(19) United States
(12) Patent Application Publication
(10) Pub. No.: US 2026/0278836 A1
(43) Pub. Date: Sep. 17, 2026

(54) OPTIMIZING SEARCHING OF A PREVIOUSLY VIEWED SCENE FOR A HEAD-MOUNTED DISPLAY DEVICE

(71) Applicant: SAMSUNG ELECTRONICS CO., LTD., Suwon-si (KR)

(72) Inventors: Rajat Kumar JAIN, Bangalore (IN); Sarthak SENGUPTA, Bangalore (IN); Sujoy SAHA, Bangalore (IN); Rajas Jayant JOSHI, Bangalore (IN)

(73) Assignee: SAMSUNG ELECTRONICS CO., LTD., Suwon-si (KR)

(21) Appl. No.: 19/680,286

(22) Filed: May 18, 2026

Related U.S. Application Data
(63) Continuation of application No. PCT/KR2025/014384, filed on Sep. 16, 2025.

(30) Foreign Application Priority Data
Sep. 16, 2024 (IN) 202441069924

(51) Int. Cl. G06T 7/73; G02B 27/01; G06F 16/55; G06F 16/901

(52) U.S. Cl. CPC G06T 7/74; G02B 27/017; G06F 16/55; G06F 16/9024; G02B 2027/0138

(57) ABSTRACT

Provided is a method for optimizing searching of a previously viewed scene for a head-mounted display (HMD) device including receiving a plurality of views corresponding to a real-world scene, determining landmarks within each view, determining a co-visibility of the landmarks between different views, generating a co-visibility graph based on the co-visibility of the landmarks between the different views, the co-visibility graph including multiple levels, which include nodes that represent at least one view and edges between the nodes that represent the co-visibility of the landmarks between the at least one view, and detecting a pose of the HMD device based on the co-visibility graph of the real-world scene.

### CROSS-REFERENCE TO RELATED APPLICATIONS

This application is a bypass continuation of International Application No. PCT/KR 2025/014384, filed on Sep. 16, 2025, which is based on and claims priority to Indian Patent Application No. 202441069924 filed on Sep. 16, 2024 in the Indian Patent Office, the disclosure of which is incorporated by reference herein in their entirety.

### BACKGROUND

### 1. Field

Embodiments of the present disclosure relate to image processing. More particularly, embodiments of the present disclosure relate to a system and method for optimizing searching of a previously viewed scene for a head-mounted display (HMD) device.

### 2. Description of Related Art

Simultaneous localization and mapping (SLAM) is a technology utilized for constructing or updating a map of a particular location while concurrently tracking a user's pose within that location. SLAM is employed in a wide array of applications, including robotics, augmented reality (AR), and self-driving cars, among others. The technology includes two components including localization and mapping. Localization is responsible for determining the user's position and orientation within the map, while mapping involves creating a map of the location as the user navigates through it.

In SLAM, the user's position and orientation, along with the generated map, may be represented using a graph, such as a co-visibility graph. A co-visibility graph includes nodes and edges, where nodes represent the user's pose at specific times, and edges represent the constraints between these poses, derived from sensor measurements. These constraints encode the relative position and orientation between the poses. Additionally, the graph may include landmarks or features as nodes, with edges representing the user's observations of these landmarks. Co-visibility graphs are instrumental in providing a configuration of the user's path and a map of the environment or location in which the user's path is monitored.

However, the SLAM process encounters several challenges as the user explores more areas within a particular location. One issue is the increase in the number of landmarks, which leads to a corresponding increase in the number of nodes in the co-visibility graph. As the number of nodes grows, the time required to search for a specific landmark within the image frames also increases, as each search involves comparing the current frame with all nodes in the co-visibility graph. This increase in computational cost results in longer processing times for the image frames, potentially causing frame drops and negatively impacting the user experience.

Further, the heightened computational demand for each search task leads to increased CPU cycles, which in turn results in higher power consumption, elevated device temperatures, and reduced battery life, particularly in head-mounted display (HMD) devices. Existing methods attempt to manage the co-visibility graph's growth by maintaining the complete graph and employing frame or pose culling techniques to prevent exponential growth and keep computations in check. The conventional mechanisms are often compromise accuracy and involve redundant calculations, especially when a scene is revisited.

Given these challenges, there is a need to address the aforementioned problems and disadvantages associated with SLAM or, at the least, provide a viable alternative.

### SUMMARY

According to an aspect of the disclosure there is provided a method for optimizing searching of a previously viewed scene for a head-mounted display (HMD) device. In an embodiment of the disclosure, the method may include receiving, by the HMD device, a plurality of views at corresponding times corresponding to a real-world scene as a user wearing the HMD device moves. In an embodiment of the disclosure, the method may include determining, by the HMD device, landmarks included in each view of the plurality of views. In an embodiment of the disclosure, the method may include determining, by the HMD device, a co-visibility of the landmarks between different views of the plurality of views, the co-visibility indicating same landmarks being included in different views of the plurality of views. In an embodiment of the disclosure, the method may include generating, by the HMD device, a co-visibility graph based on the co-visibility of the landmarks between the different views of the plurality of views, the co-visibility graph comprising multiple levels, each level of the multiple levels comprises nodes corresponding to at least one view of the plurality of views, and edges between the nodes that represent the co-visibility of the landmarks between the at least one view of the plurality of views. In an embodiment of the disclosure, the method may include detecting, by the HMD device, a pose of the HMD device based on the co-visibility graph of the real-world scene.

According to an aspect of the disclosure, there is provided a method for optimizing searching of a previously viewed scene for a head-mounted display (HMD) device. In an embodiment of the disclosure, the method may include receiving, by the HMD device, at least one input image, wherein the at least one input image includes a plurality of views corresponding to a real-world scene. In an embodiment of the disclosure, the method may include determining, by the HMD device, landmarks included in the at least one input image received. In an embodiment of the disclosure, the method may include retrieving, by the HMD device, a co-visibility graph corresponding to the landmarks included in the at least one input image received, the co-visibility graph determined being pre-stored in a memory of the HMD device, and the co-visibility graph comprising a plurality of levels, each level includes nodes corresponding to at least one view of the plurality of views, and edges between the nodes corresponding to the co-visibility of the landmarks between the at least one view of the plurality of views. In an embodiment of the disclosure, the method may include determining, by the HMD device, a correlation between the landmarks of the at least one input image with at least one level of the plurality of levels of the co-visibility graph, and detecting, by the HMD device, a pose of the HMD device based on the correlation.

According to an aspect of the disclosure, there is provided a head-mounted display (HMD) device for optimizing searching of a previously viewed scene, including a memory storing a program or at least one instruction and at least one processor configure to individually or collectively execute the program or the at least one instruction. In an embodiment of the disclosure, the program or the at least one instruction, when executed individually or collectively by the at least one processor, cause the HMD device configured to receive a plurality of views corresponding to a real-world scene. In an embodiment of the disclosure, the program or the at least one instruction, when executed individually or collectively by the at least one processor, cause the HMD device configured to determine landmarks included in each view of the plurality of views. In an embodiment of the disclosure, the program or the at least one instruction, when executed individually or collectively by the at least one processor, cause the HMD device configured to determine a co-visibility of the landmarks between different views of the plurality of views, the co-visibility indicating same landmarks being included in the different views of the plurality of views. In an embodiment of the disclosure, the program or the at least one instruction, when executed individually or collectively by the at least one processor, cause the HMD device configured to generate a co-visibility graph based on the co-visibility of the landmarks between the different views of the plurality of views, the co-visibility graph comprising multiple levels, each level of the multiple levels comprises nodes corresponding to at least one view of the plurality of views, and edges between the nodes that represent the co-visibility of the landmarks between the at least one view of the plurality of views. In an embodiment of the disclosure, the program or the at least one instruction, when executed individually or collectively by the at least one processor, cause the HMD device configured to detect a pose of the HMD device based on the co-visibility graph of the real-world scene.

### BRIEF DESCRIPTION OF DRAWINGS

These and other features, aspects, and advantages of an embodiment of the disclosure are illustrated in the accompanying drawings, throughout which like reference letters indicate corresponding parts in the various figures. An embodiment of the disclosure herein will be better understood from the following description with reference to the drawings, in which:

FIG. 1 is a block diagram that illustrates a schematic of an HMD device implemented to carry out the disclosed subject matter according to an embodiment of the disclosure;

FIG. 2 is a block diagram that illustrates an exploded view of an HMD controller of the HMD device of FIG. 1 according to an embodiment of the disclosure;

FIG. 3 is a block diagram that illustrates an exploded view of a multi-level co-visible graph generation component of the HMD controller of the HMD device of FIG. 2 according to an embodiment of the disclosure;

FIG. 4 is a block diagram that illustrates an exploded view of a landmark confidence component of the HMD controller of the HMD device of FIG. 2 according to an embodiment of the disclosure;

FIG. 5 is a block diagram that illustrates an exploded view of a landmark search component of the HMD controller of the HMD device of FIG. 2 according to an embodiment of the disclosure;

FIG. 6 is a block diagram that illustrates an exploded view of a frame addition component of the HMD controller of the HMD device of FIG. 2 according to an embodiment of the disclosure;

FIG. 7 is a schematic diagram that illustrates capturing of a plurality of image frames corresponding to consecutive views and non-consecutive views of a real-world scene using the HMD device according to an embodiment of the disclosure;

FIG. 8A is a schematic diagram that illustrates a primary level co-visibility graph according to an embodiment of the disclosure;

FIG. 8B is a schematic diagram that illustrates a user timeline based on which the primary level co-visibility graph of FIG. 8A is generated according to an embodiment of the disclosure;

FIG. 9 is a schematic diagram that illustrates generation of a multi-level co-visibility graph generated at different levels based on the primary level co-visibility graph of FIG. 8A according to an embodiment of the disclosure;

FIGS. 10A and 10B are flow diagrams that illustrate a method for optimizing searching of a previously viewed scene for the HMD device according to an embodiment of the disclosure;

FIG. 11 is a flow diagram that illustrates a method for detecting a pose of the HMD device according to an embodiment of the disclosure; and

FIG. 12 is a flow diagram that illustrates a method for detecting a pose of the HMD device using a pre-stored co-visibility graph according to an embodiment of the disclosure.

It is noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing is exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and techniques are omitted so as to not unnecessarily obscure the embodiments herein. Also, the various embodiments described herein are not necessarily mutually exclusive, as some embodiments may be combined with one or more other embodiments to form new embodiments. The term “or” as used herein, refers to a non-exclusive or, unless otherwise indicated. The examples used herein are intended merely to facilitate an understanding of ways in which the embodiments herein may be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

In the prior art, the number of landmarks may tend to rise when the user visits more regions (for instance, within a specific location). An increase in landmarks causes the co-visibility graph to have an increase in nodes. The time required to look for a landmark inside the image frames rises with the number of nodes since each node in the co-visibility graph must be compared. The processing time of the image frames grows with the computing cost. This causes a frame loss and might generally degrade the user experience. Every search task will consume a significant amount of CPU cycles because of the extra calculation involved. A higher CPU cycle count might lead to excessive power consumption, heating, and a rise in temperature, as well as a shorter battery life for the HMD device. Existing approaches save the whole co-visibility graph and use frame/pose culling to prevent the co-visibility graph from growing exponentially and to control calculations. However, the existing systems compromise on accuracy and necessitate duplicate computations when revisiting a scene.

The proposed solution creates a multi-level co-visibility graph where the highest level retains the entire tree. As one descends the levels, only high-confidence landmarks and frames with the highest visibility of such landmarks are retained, which leads to faster localization at the lowest level. As one ascends the levels, only frames that show the scene are processed that were selected at a lower level. This results in a smaller search space and fewer calculations as compared to the current methods. The proposed solution may be used with any HMD/XR/AR device where localization and mapping of user pose is a primary task.

Maintaining a multi-level hierarchical co-visibility graph allows the proposed solution to execute frame search in a co-visibility graph more quickly and effectively. By using more stringent co-visibility guidelines, the co-visibility graph retains a subset of image frames at each level. When a frame of an image has to be searched in the co-visibility graph, the search begins at the lowest level, moves up, and only reaches a portion of the image frame count since the search region is limited based on the lower level search. This solution reduces the problem's overall complexity from searching every image frame to only a subset of them. Additionally, the hierarchical approach ensures that only the relevant and high-confidence landmarks are considered at each level, thereby enhancing the accuracy and efficiency of the localization process. The proposes solution not only mitigates the computational burden but also optimizes the power consumption and thermal management of the HMD device, thereby extending its operational lifespan and improving the overall user experience.

It should be appreciated that the blocks in each flowchart and combinations of the flowcharts may be performed by one or more computer programs which include computer-executable instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP), a communication processor (CP), a graphical processing unit (GPU), a neural processing unit (NPU), a microprocessor unit (MPU), a system on chip (SoC), an IC, or the like.

The processor may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In the present disclosure, a landmark refers to a visual element that can be extracted or identified from an image or view and used for tasks such as matching, tracking, or pose estimation. The landmarks may include, for example, objects and features such as structures, edges, and textures that are visually distinguishable within each view. Accordingly, in the present disclosure, the terms “objects” and “features” may be understood as being encompassed by or represented as “landmarks”

An embodiment of the disclosure provide optimizing searching of a previously viewed scene (real-world scene) for a head-mounted display (HMD) device worn on the head of a user.

An embodiment of the disclosure also provide generating a multi-level co-visibility graph that helps in faster re-localization of the frame/pose in the real-world scene with fewer comparisons when compared with existing methods.

An embodiment of the disclosure also provide constructing the multi-level co-visibility graph across different levels using landmark confidence features as a base. The co-visibility of the landmarks is determined, and high-confidence landmarks and image frames with the visibility of such landmarks are retained.

An embodiment of the disclosure also provide selecting a candidate image frame for the next level after comparing the co-visibility among the chosen candidates. The image frame with the co-visibility or highest co-visibility is selected as the representative candidate for the next level.

An embodiment of the disclosure also provide constructing the multi-level co-visibility graph using a bottom-up approach where the current image frame is first localized in the bottom-most level and then moved up the chain. Yet another object of the embodiments herein is to detect the pose of the user wearing the HMD device based on the multi-level co-visibility graph constructed/generated.

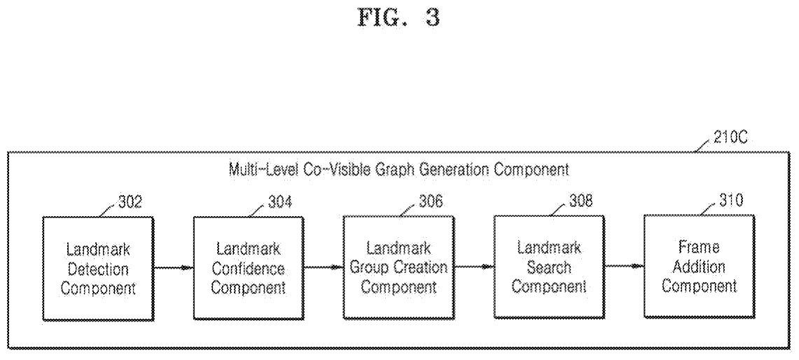

Referring now to the drawings and more particularly to FIGS. 3 through 13 where similar reference characters denote corresponding features consistently throughout the figures, there are shown preferred embodiments.

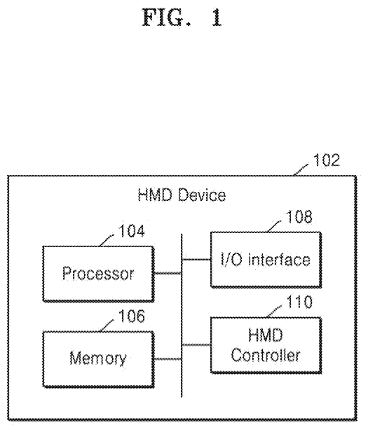

FIG. 1 is a block diagram that illustrates a schematic of the HMD device 102 implemented to carry out the disclosed subject matter according to an embodiment of the disclosure. As shown, the HMD device 102 includes a processor 104, a memory 106, an input/output (I/O) interface 108, and an HMD controller 110. For example, the HMD device 102 may include, but is not limited to, a personal computer (PC), desktop, laptop, smartphones, camera, and the like.

The processor 104 may be a component that controls a series of processes to cause the HMD device 102 to operate according to embodiments of the disclosure as described below, and may consist of one or a plurality of processors. The one or plurality of processors included in the processor 104 may be circuitry, such as a system on chip (SoC), an integrated circuit (IC), or the like. The one or plurality of processors included in the processor 104 may be general-purpose processors such as a central processing unit (CPU), a microprocessor unit (MPU), an application processor (AP), a digital signal processor (DSP), etc., dedicated graphics processors such as a graphics processing unit (GPU) and a vision processing unit (VPU), dedicated AI processors such as a neural processing unit (NPU), or dedicated communication processors such as a communication processor (CP). When the one or plurality of processors included in the processor 104 are a dedicated AI processor, the corresponding AI dedicated processor may be designed with a hardware structure specialized for processing a specific AI model.

The processor 104 may write data to the memory 106 or read data stored in the memory 106, and in particular, execute a program or at least one instruction stored in the memory 106 to process data according to predefined operation rules or AI models. Thus, the processor 104 may perform operations described according to embodiments of the disclosure as described below, and operations described in the disclosure as being performed by the HMD device 102 or the components, i.e., the PEFT model 30 to the cache memory 350, included in the HMD device 102 may be considered as being performed by the processor 104 unless otherwise specified.

The processor 104 communicates with the memory 106, the I/O interface 108, and the HMD controller 110. The processor 104 is configured to implement instructions stored in the memory 106 and to perform various methods. The processor 104 may include one or a plurality of processors. The processor 104 may be a general-purpose processor such as, for example, a central processing unit (CPU), an application processor (AP), or the like, a graphics-only processing unit such as a graphics processing unit (GPU), a visual processing unit (VPU), and/or an Artificial Intelligence (AI) dedicated processor such as a neural processing unit (NPU).

The HMD device 102 has a memory 106 that is accessed through the processor 104. The memory 106 is not restricted to volatile or non-volatile memory and may consist of one or more computer-readable storage media. Further, the memory 106 may contain non-volatile storage elements such as, for example, magnetic hard disks, optical disks, floppy disks, flash memories, EPROM, or EEPROM memories.

The I/O interface 108 transmits information between the memory 106 and external peripheral devices. The peripheral devices are the input-output devices associated with the electronic device (300). Furthermore, the HMD controller 110 communicates with the I/O interface 108 and the memory 106. The HMD controller 110 is a hardware that is realized through the physical implementation of both analog and digital circuits, including logic gates, integrated circuits, microprocessors, microcontrollers, memory circuits, passive and active electronic components, as well as optical components.

It should be understood that the HMD controller described in the embodiments may be implemented by, or correspond to, one or more processors of the HMD device. Therefore, operations described as being performed by the HMD controller may be understood as being executed by such processor(s). Although the embodiments describe that operations are performed by the HMD controller, it is to be understood that the controller may be implemented by a processor, and thus, the described operations may be equivalently understood as being performed by the processor.

In an embodiment of the disclosure, the HMD controller 110 receives a plurality of views at corresponding times corresponding to a real-world scene as a user wearing the HMD device 102 moves. For example, the real-world scene may correspond to, for example, a living room, a home street view, office view, and the like. The HMD device 102 presents visual information directly to the user's eyes, creating an immersive visual experience. The views may be captured using at least one outward-facing camera of the HMD device 102. This outward-facing camera continuously captures the user's environment, enabling the HMD device 102 to provide real-time visual feedback that enhances the user's interaction with the virtual elements overlaid on the real-world scene. As the user navigates through different environments, the HMD controller 110 dynamically adjusts the visual content to maintain a coherent and immersive experience.

In an embodiment of the disclosure, the HMD controller 110 determines objects or features within each view received. The objects or features correspond to key elements, common elements, or important elements within each view. For example, when the real-world scene corresponds to a living room, then the objects or features may refer to a sofa, television (TV), sofa table, and the like. The identification of these objects or features is crucial for the HMD device 102 to more accurately overlay virtual elements onto the real-world scene. By recognizing and tracking these elements, the HMD controller 110 ensures that virtual objects interact seamlessly with their real-world counterparts, enhancing the user's sense of presence and immersion. The process of object recognition may involve advanced computer vision techniques, such as machine learning algorithms, to more accurately identify and classify the various elements within each view.

In an embodiment of the disclosure, the HMD controller 110 determines a co-visibility of the objects or the features between consecutive views and non-consecutive views of the plurality of views. In an embodiment of the disclosure, the co-visibility may be formed with respect to each of the consecutive views and the non-consecutive views. In other words, the co-visibility may be determined between different views among the plurality of views. The consecutive views correspond to views or scenes that are presented one after another in a continuous and sequential order. Watching a video where each frame follows the previous one without any breaks or interruptions is an example of consecutive views. The non-consecutive views correspond to views or scenes that are not presented in a direct sequential order, as there may be gaps, skips, or jumps between the views. Skipping ahead in a video to a different point in time is an example of non-consecutive views. Further, the co-visibility indicates the presence of the same objects or the same features in each of the views. The shared view area between two image frames is referred to as the co-visible area, and the frames are referred to as co-visible when they record the same subject from different angles or directions. This co-visibility information is essential for maintaining spatial consistency and continuity in the virtual environment, allowing the HMD device 102 to provide a seamless and coherent visual experience.

In an embodiment of the disclosure, the HMD controller 110 generates a co-visibility graph based on the co-visibility of the objects or the features between the consecutive views and the non-consecutive views. In an embodiment of the disclosure, the co-visibility graph may refer to a graph data structure that represent co-visibility between the different views among the plurality of views. For example, the co-visibility graph may represents relationships between different viewpoints or camera poses based on the objects or features that are visible from those viewpoints.

In an embodiment of the disclosure, the co-visibility graph generated includes multiple levels or may be a multi-level co-visibility graph. In an embodiment of the disclosure, the co-visibility graph generated includes nodes and edges.

In an embodiment of the disclosure, the node corresponding to at least one of view of the plurality of views. Here, the view may be captured image frame obtained from a specific viewpoint, camera pose, or location from which the objects or features are observed. In an embodiment of the disclosure, the edges may represent the co-visibility of the objects or the features between the at least one view of the plurality of views. For example, the edges between two or more nodes indicate that there is a significant overlap in the features or objects visible from at least two view. Here, the at least two view are co-visible or share common visual elements. This graph structure allows the HMD controller 110 to more efficiently manage and retrieve visual information, facilitating tasks such as scene reconstruction, object tracking, and navigation within the virtual environment.

In an embodiment of the disclosure, the HMD controller 110 receives image frames corresponding to the consecutive views and the non-consecutive views of the real-world scene. The term image frames may refer to separate images/pictures that give the impression of motion when they are shown quickly one after the other. The HMD controller 110 then determines at least one key image frame from each image frame received. The key image frame may refer to an important frame in a sequence of images or video that serves as a reference point or anchor for defining motion changes or structure within the consecutive sequence and the non-consecutive sequence. The key image frame may be used as reference points for building a map, estimating camera poses, reconstructing three-dimensional (3D) structures, and the like. The key image frames are chosen based on criteria like distinctiveness, feature richness, coverage of new areas, and the like. Further, the objects or features within the key image frame(s) are then determined. These key frames ensure the accuracy and reliability of the visual information processed by the HMD controller 110, enabling robust performance in various applications such as augmented reality, virtual reality, and mixed reality experiences.

In an embodiment of the disclosure, the HMD controller 110 determines groups to group each image frame into. The groups of each image frame are determined based on the objects or features within each image frame and have common features. Each object or feature within the image frames is added as a part of at least one group. For example, the groups may include a highest confidence feature group, an intermediate confidence feature group, a less high confidence feature group, and a least confidence features group. For instance, the objects or features may be added to the highest confidence feature group based on one or more criteria such as chances of staying at the same location are higher, have high contrast compared to its surroundings, static nature, distance from the user wearing the HMD device 102, and the like.

In an embodiment of the disclosure, the HMD controller 110 constructs a co-visibility graph of the real-world scene based on the at least one key image frame in at least one group. The HMD controller 110 first generates a primary level co-visibility graph of the real-world scene for each group corresponding to at least one key image frame. The primary level co-visibility graph generated includes nodes and edges. The nodes correspond to views captured by the camera of the HMD device 102 as the user moves over a time gap. Nodes corresponding to new/different views are added as the user continues to move over the time gap. Edges are added between two nodes if the corresponding images share a sufficient number of matched features. The weight of the edges may represent the number of shared features, the quality of the matches, or other metrics indicating the strength of the co-visibility. The edges are added based on the co-visibility of the objects or the features between the new views and existing views. Further, only landmark features and co-visibility edges information may be stored in the primary level co-visibility graph.

In an embodiment of the disclosure, the HMD controller 110 determines at least one key image frame from each group having a maximum visibility. The HMD controller 110 calculates (obtains) or determines a co-visibility score for each node in the primary level co-visibility graph. The co-visibility score is a score used to quantify a degree of overlap or shared visibility between two or more views or poses of the camera of the HMD device 102 based on the common features or landmarks observed. A higher score indicates a stronger co-visibility, indicating that the two views are more closely related in terms of what is viewed along with the common features or landmarks within them.

In an embodiment of the disclosure, the HMD controller 110 generates one or more secondary level co-visibility graphs of the real-world scene. The secondary level co-visibility graphs are generated based on the at least one key image frame having the maximum visibility for each group. The co-visibility score generated for each node is compared with a threshold value. The nodes in which the co-visibility score is greater than the threshold value are considered and added to the next level. The landmarks, poses, and key frames are stored in a map. The co-visibility graph stores the image frame as nodes and the co-visible frames are connected as edges. The information about the landmarks is read directly from the image frames stored in the map.

In an embodiment of the disclosure, the HMD controller 110 detects the pose of the HMD device 102 based on the co-visibility graph generated of the real-world scene. The pose is detected using a pose detection process. When an input image is received or captured by the HMD device 102, at least one landmark from the input image(s) is extracted. Extracting landmarks from the input image(s) involves identifying one or more key points of interest that correspond to specific features within the image(s). For example, when the input image depicts a living room, the landmarks extracted may be a sofa, center table, television, and the like.

In an embodiment of the disclosure, the HMD controller 110 compares the extracted landmarks from the input image with poses and frames present at a lowest level of the co-visibility graph. The lowest level corresponds to a base level of the co-visibility graph where landmark observations are initially captured from multiple image frames. For instance, feature mapping techniques or geometric verification techniques may be used for finding correspondences. Once the correspondences are found, the HMD controller 110 assesses a similarity between the input image landmarks and those in the co-visibility graph, potentially refining poses.

In an embodiment of the disclosure, the HMD controller 110 selects the image frame at the lowest level that exhibits the highest co-visibility with the extracted landmarks from the input image. The co-visibility graph provides information about the landmarks observed in each image frame and their visibility relationships. Each node in this co-visibility graph represents an image frame and edges represent shared landmarks between the image frames. The HMD controller 110 matches the extracted landmarks with the landmarks present in the input image using a feature matching process. Then the co-visibility is measured/determined by counting the number of matched landmarks between the input image and the image frame in the co-visibility graph. The image frame with the highest co-visibility is then selected by tracking the image frame that has the highest number of matching landmarks.

In an embodiment of the disclosure, the HMD controller 110 identifies a group of image frames that capture the same scene in a subsequent higher level of the co-visibility graph. The group of image frames may be identified by using the selected image frame from a lowest level as a base. The levels of the co-visibility graph represent a hierarchical grouping of the image frames where higher levels capture larger or more complete views of the real-world scene. For example, the group of image frames may refer to image frames that have high co-visibility (for example, they share many common landmarks) with the base frame and with each other. The HMD controller 110 compares the extracted landmarks from the input image with the image frames at each subsequent higher level. As a result, the image frame with the highest co-visibility is selected until a top level of the co-visibility graph is reached.

In an embodiment of the disclosure, the HMD controller 110 determines whether a stop condition is satisfied. The HMD controller 110 determines a first co-visibility score and one or more second co-visibility scores. The first co-visibility score corresponding to the extent to which the landmarks in the input image are visible in the plurality of images frames at the current level of the co-visibility graph. The second co-visibility scores corresponding to the extent to which the landmarks in the input image are visible in the plurality of images frames at each subsequent higher level of the co-visibility graph. The first co-visibility score may correspond to a maximum co-visibility at the current level. The second co-visibility scores may correspond to the maximum co-visibility for all the subsequent higher levels or lower levels. The HMD controller 110 then compares the first co-visibility score with the second co-visibility scores. When the first co-visibility score is less than half of at least one second co-visibility score, then the pose search is stopped or halted. When the first co-visibility score is equal to or greater than half of at least one second co-visibility score, the pose search continues until the first co-visibility score reaches to less than half of at least one second co-visibility score of the one or more second co-visibility scores. For example, the total number of comparisons have been reduced to 8, when compared with previous methods or techniques. Thus, the proposed solution provides at least 2× boost to the performance even for relatively smaller maps.

In an embodiment of the disclosure, the HMD controller 110 determines the co-visibility using a co-visibility determination process. The HMD controller 110 identifies distinct features and identifiable features within the at least one key image frame. For instance, the distinct features may refer to distinguishable features in the key image frame that stand out from the rest of the real-world scene. For example, distinct features may include corners, edges, texture-rich areas, and the like. The identifiable features may refer to features that may be recognized across different views, scales, and lighting conditions. For example, the distinct features and identifiable features may be identified or determined using techniques such as, scale-invariant feature transform (SIFT), Harris corner detection, ORB, and the like.

In an embodiment of the disclosure, the HMD controller 110 generates feature descriptors that numerically represent the identifiable features. The feature descriptors provide a compact and robust numerical representation of identifiable features in the key image frame. For example, the feature descriptors may be numerical vectors that describe appearance around the key points. The key points represent locations in the image that are distinctive and may be more reliably matched across different images.

In an embodiment of the disclosure, the HMD controller 110 bundles the generated feature descriptors into a comprehensive dataset. Bundling feature descriptors into a comprehensive dataset involves extracting descriptors from each image and aggregating them into a structured format. The comprehensive dataset includes the feature descriptors, labels, and key points.

In an embodiment of the disclosure, the HMD controller 110 determines similarities and matches between a query image and the at least one key image frame based on the stored comprehensive dataset. The query image refers to finding objects that are relevant to a user query within image databases. First, key points and descriptors are extracted from the query image using feature extraction methods. Once extracted, matching techniques (for example, brute-force (BF) matcher, Deep-learning (DL) matcher) are used to find correspondences between the query image descriptors and the stored descriptors in the comprehensive dataset. The correspondences are then analyzed to determine which key image frame(s) from the comprehensive dataset are similar to the query image which may be done by aggregating the number of good matches or by using other metrics. The HMD controller 110 may then search for matching feature descriptors between the at least one key image frame and other images.

In an embodiment of the disclosure, the HMD controller 110 determines the co-visibility based on a count of the matching feature descriptors. The co-visibility is determined by counting the number of matching feature descriptors between two images. The co-visibility provides a measure of how much of the scene is visible in both images. A higher co-visibility indicates a higher degree of similarity or co-visibility between the key image frame and the other images.

In an embodiment of the disclosure, the HMD controller 110 determines the objects or the features within each view (consecutive views and non-consecutive views) using a feature extraction process. The HMD controller 110 extracts feature points from the image frame. For example, the feature points may include structures, edges, and objects in the image frames.

In an embodiment of the disclosure, the HMD controller 110 determines feature descriptors for the extracted feature points. The feature descriptors provide a numerical representation of the local image patches around the detected feature points. The feature descriptors may be used for comparing and matching features between different images. The feature descriptors are designed to be illumination, translation, and scale invariant. Further, the feature descriptors are represented as high-dimensional vectors encapsulating local image gradient information around each feature point.

In an embodiment of the disclosure, the HMD controller 110 estimates a depth information using an epi-polar geometry in the case of stereo cameras by triangulating corresponding points in the image frames. Estimating the depth information using epi-polar geometry in stereo camera systems involves triangulating matched feature points in the image frames from two stereo cameras. This process leverages the geometric relationships between the two camera views to compute the 3D coordinates of points in the real-world scene. The stereo cameras are calibrated to obtain intrinsic parameters (for example, focal length, principal point, distortion coefficients) and extrinsic parameters (for example, rotation and translation between the cameras). Feature points are then detected and matched between the stereo cameras using feature matching techniques.

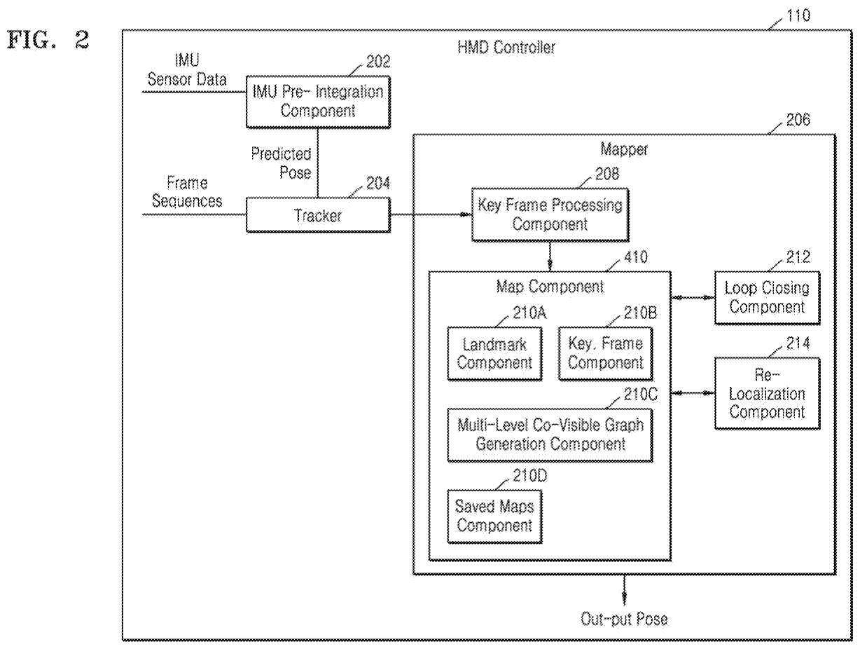

FIG. 2 is a block diagram that illustrates an exploded view of the HMD controller 110 of the HMD device 102 of FIG. 1 according to an embodiment of the disclosure. As shown, the exploded view of the HMD controller 110 includes an inertial measurement unit (IMU) pre-integration component 202, a tracker 204, and a mapper 206. The mapper 206 includes a key frame processing component 208, a map component 410, a loop closing component 212, and a re-localization component 214. The map component 410 includes a landmark component 210A, a key frame component 210B, a multi-level co-visibility graph generation component 210C, and a saved maps component 210D. Each component is explained in further detail below.

In an embodiment of the disclosure, the IMU pre-integration component 202 measures acceleration and angular velocity, which may be used to track the orientation and position of the HMD device 102. The IMU pre-integration component 202 receives IMU sensor data as an input. For example, the IMU sensor data may include gyrometer and accelerometer sensor data. The IMU pre-integration involves aggregating the IMU sensor data over a period of time or between the at least one key image frame. This may be done by pre-computing certain quantities such as velocity and position changes based on the IMU sensor data received. These quantities may be used for estimating an initial pose or predicted pose of the camera of the HMD device 102.

Upon receiving the IMU sensor data along with the input frame sequence, the IMU pre-integration component 202 processes this data to obtain a change in translation ΔT and a change in rotation ΔR. The translation refers to movement of the HMD device 102 from one location to other locations. The change in translation represents a difference in position between the initial and final locations of the HMD device 102. Further, the rotation refers to change in an orientation of the HMD device 102 along or around an axis. The change in rotation represents the difference in orientation between the initial and final locations or positions of the HMD device 102.

In an embodiment of the disclosure, the tracker 204 receives the predicted pose as an input from the IMU pre-integration component 202 along with frame sequences (input frames) and processed IMU data as another input. The tracker 204 records and manages the predicted pose details along with the frame sequence details received as inputs. The recording and management may be performed over a certain time. The tracker 204 also processes the input data received from the IME pre-integration component 202 to calculate a frame pose and determine whether the current frame(s) is a key image frame. The frame pose along with the image frames are passed to the mapper 206 for pose refinement.

In an embodiment of the disclosure, the key frame processing component 208 determines at least one key image frame from the image frames. The key image frame is a significant frame in a series of photos or a video that functions as an anchor or reference point to define motion changes or structure in both the consecutive and non-consecutive sequences. Rebuilding 3D buildings, making maps, predicting camera postures, and other tasks may all be accomplished with the help of the key image frame. Key picture frames are selected using many criteria such as uniqueness, richness of features, coverage of previously unexplored areas, and the like.

In an embodiment of the disclosure, the map component 410 generates a map based on the key image frames determined by the key frame processing component 208 and the information present in the tracker 204. The map may be projected to the user on a display of the HMD device 102. For example, the map generated by the map component 410 may be a scene map. The scene map presents a layout of the real-world scene currently being viewed by the user. The landmark component 210A presents the landmarks determined on the map, the key frame component 210B presents the key frame on the map, and the saved maps component 210D saves the map(s) generated. Further, the multi-level co-visible graph generation component 210C generates a multi-level co-visibility graph that includes nodes and edges. The nodes correspond to views captured by the camera of the HMD device 102 as the user moves over a time gap. The edges are added between the nodes if the corresponding image frames share a number of matched features.

The map component 410 initially detects features and then creates landmarks from these computed features. These locations, features, and critical frames are added to the currently active map. The map component 410 then calculates (obtains) co-visibility using the identified features and landmarks before adding the frame to the multi-level co-visible graph. After adding the frame to the map, the map component 410 uses the multi-level co-visibility graph to determine whether or not the present scene has been viewed before. The map component 410 sends this information to the loop closing component 212, which closes the loop in such scenario to correct the accumulated drift. When the user loses tracking, the map component 410 sends this information to the re-localization component 214, which re-localizes using the stored co-visibility graph. When the scene has previously been visited, the re-localization component 214 restores its tracking. The output user pose is the stance that has been refined by loop closing and re-localization.

In an embodiment of the disclosure, each image frame is compared with a threshold value/limit to determine which image frames are key image frames. When the number of marched landmarks is less than the threshold value (for example, 120), then the current image frame is marked as a key image frame. When an image frame is identified as a key image frame, the key image frame(s) are added to the active map. Once added to the map, new feature points are recognized and new landmarks are built for the real-world scenario. Furthermore, the key picture frame(s) are added to the multi-level co-visible graph and may be used when the user revisits the same scenario. When user posture tracking is lost and cannot be detected or located in the multi-level co-visible graph, the active map is preserved in memory for later use when looking for a scene at one or more timestamps in the future.

In an embodiment of the disclosure, the loop closing component 212 detects loop closures. The loop closure is identified when a user returns to the same scene on the map. The co-visibility of the current image is compared to images in the stored map in order to find loops, which are identified by a co-visibility threshold. After a loop has been identified, co-visible 3D landmarks and their projections are used to optimize the partial map from the loop candidate to the current frame in order to minimize the pose difference between the loop candidate and current frame. Detecting loop closure is used for improving the accuracy of the map and the localization of the user wearing the HMD device 102. Loop closure detection helps reduce errors that may have built up over time as the user navigates through the real-world scene.

In an embodiment of the disclosure, the re-localization component 214 assists the HMD device 102 to recover from tracking failures. The map component 410 builds a map of the real-world scene while simultaneously tracking the location of the user wearing the HMD device 102. When the user becomes lost or unsure of their location due to sensor errors, occlusions, or challenging environmental conditions, re-localization helps it regain the position within the map. The tracking of the user's pose may be unsuccessful for reasons such as low feature counts, fast movements, inadequate lighting, and the like. In these situations, the tracker 204 asks the map component 410 to use the map to locate the tracker in the scene, at which point the tracking is continued. Further localizing the user may become difficult when tracking is lost. In such an example, the current map is cached. The stored map in the saved maps component 410 is scanned to see if the scene that is displayed in the current frame has already been visited once. The current map is combined with the stored maps when they are located. The co-visibility score is used to verify a scene in the stashed map.

Further, a loop is identified when the user returns to the same scene on the map. The co-visibility of the current image is compared to images in the stored map in order to find loops, which are identified by a co-visibility threshold. After a loop has been identified, co-visible 3D landmarks and their projections are used to optimize the partial map from the loop candidate to the current frame in order to minimize the pose difference between the loop candidate and current frame.

FIG. 3 is a block diagram that illustrates an exploded view of the multi-level co-visible graph generation component 210C of the HMD controller 110 of the HMD device 102 of FIG. 2 according to an embodiment of the disclosure. As shown, the exploded view of the multi-level co-visible graph generation component 210C includes a landmark detection component 302, a landmark confidence component 304, a landmark group creation component 306, a landmark search component 308, and a frame addition component 310. Each component is explained in further detail below.

In an embodiment of the disclosure, the landmark detection component 302 detects or determines landmarks within an image frame. The landmarks may be detected using neural networks trained to detect the landmarks from a dataset of images. The landmark confidence component 304 determines a feature confidence of the landmarks detected in the image frame. Feature confidence refers to a level of reliability that a particular feature detected in an image frame is accurate or correctly identified. The feature confidence affects the reliability of the map points and the overall accuracy of localization and mapping. For example, the feature confidence may be determined based on factors such as response strength, descriptor similarity, light, noise, and the like.

In an embodiment of the disclosure, the landmarks group creation component 306 adds landmarks detected in the image frame into at least one group. For example, the groups may include a highest confidence feature group, an intermediate confidence feature group, a less high confidence feature group, and a least confidence features group. For example, the landmarks may be added to the highest confidence feature group based on one or more criteria such as chances of staying at the same location are higher, have high contrast compared to its surroundings, static nature, distance from the user wearing the HMD device 102, and the like.

In an embodiment of the disclosure, the landmark search component 308 searches for similar landmarks between the image frames (for example, current frame and candidate frame) using descriptors. For example, the descriptor may be a vector that encapsulates the appearance of the landmarks within the image frame. Further, the frame addition component 310 selects one or more image frames of the input image for the next level or a subsequent higher level. The one or more image frames may be selected from at least one group to be added to the next level. The frame addition component 310 may select the image frames based on the feature confidence and a co-visibility of the features.

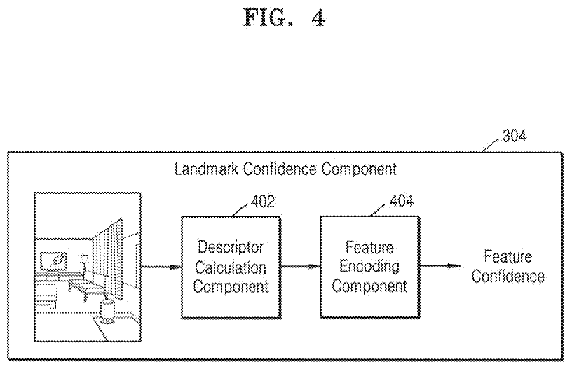

FIG. 4 is a block diagram that illustrates an exploded view of the landmark confidence component 304 of the HMD controller 110 of the HMD device 102 of FIG. 2 according to an embodiment of the disclosure. As shown, the exploded view of the landmark confidence component 304 includes a descriptor calculation component 402 and a feature encoding component 404.

In an embodiment of the disclosure, the descriptor calculation component 402 obtains feature descriptors based on the landmarks detected in the image frame/key image frame. The descriptors represent an appearance around the landmarks. The feature descriptors may be detected based on techniques such as scale-invariant feature transform (SIFT), Harris corner detection, ORB, and the like.

In an embodiment of the disclosure, the feature encoding component 404 performs a feature encoding of the feature descriptors to obtain a feature confidence. The feature encoding may be performed using a lightweight machine learning (ML) classifier. The feature encoding may be performed based on a feature location and a feature description of the landmarks. The feature location localizes the features in the image and differentiates with other features. The feature descriptor provides a description of each landmark within the image frames.

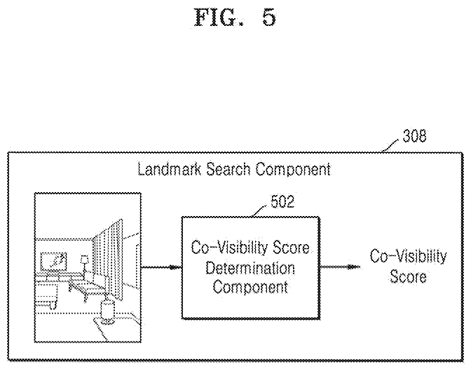

FIG. 5 is a block diagram that illustrates an exploded view of the landmark search component 308 of the HMD controller 110 of the HMD device 102 of FIG. 2 according to an embodiment of the disclosure. As shown, the exploded view of the landmark search component 308 includes a co-visibility score determination component 502.

In an embodiment of the disclosure, the co-visibility score determination component 502 determines a co-visibility score for the nodes in the co-visibility graph. The nodes represent the landmarks, and the co-visible landmarks are connected as edges in the co-visibility graph. Based on the shared characteristics or landmarks viewed, the co-visibility score is a way to measure the extent of overlap or shared visibility between two or more views or poses of the HMD device 102. A higher score denotes a greater co-visibility, which means that there are more similarities between the two viewpoints in terms of what may be viewed as well as shared landmarks or characteristics.

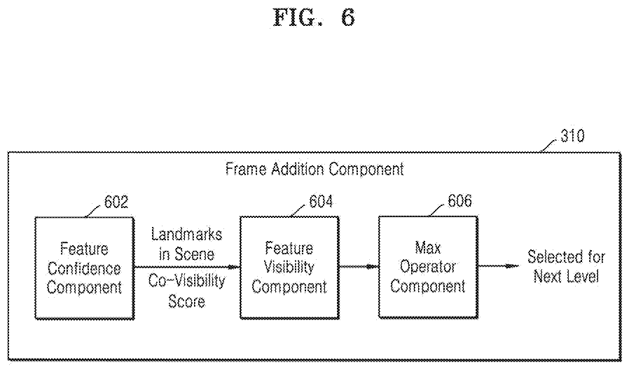

FIG. 6 is a block diagram that illustrates an exploded view of the frame addition component 310 of the HMD controller 110 of the HMD device 102 of FIG. 2 according to the embodiment herein. As shown, the exploded view of the frame addition component 310 includes a feature confidence component 602, a feature visibility component 604, and a max operator component 606.

In an embodiment of the disclosure, the feature confidence component 602 determines a confidence of the features or landmarks within the key image frame. The feature confidence refers to the level of reliability associated with a specific feature or landmark detected within the image frame. The feature confidence may be determined using feature mapping techniques (for example, SIFT, ORB). Further, the feature confidence may be represented as a probability or a confidence score ranging from 0 to 1 or 0% to 100%.

In an embodiment of the disclosure, the feature visibility component 604 is used for determining how clearly a feature/landmark within the key image frame may be detected and tracked. For example, the feature visibility may be determined based on one or more factors such as occlusion, blurriness, quality, contrast, distance, scale, and the like. When a feature is partially or fully blocked by another object/landmark in the image frame of the real-world scene, its visibility is reduced. The feature visibility may be determined based on the landmarks within the image frame and the co-visibility score determined by the co-visibility score determination component 502.

In an embodiment of the disclosure, the max operator component 606 compares the feature visibility determined by the feature visibility component 604 and the co-visibility score determined by the co-visibility score determination component 502 to determine the image frame having the maximum visibility. The image frame with the maximum visibility is then chosen or selected for the next level. An image frame may be selected from the groups for the next level.

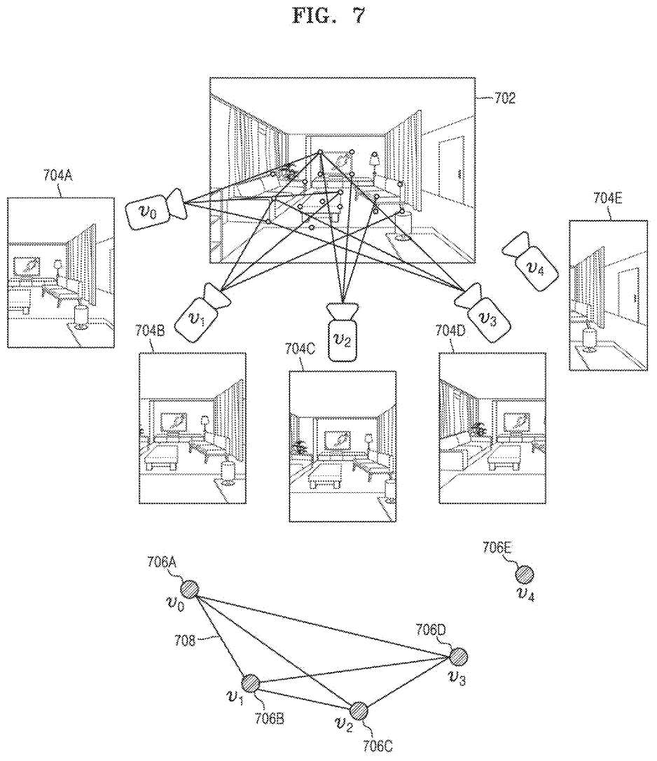

FIG. 7 is a schematic diagram that illustrates capturing of a plurality of image frames 704A-N corresponding to consecutive views and non-consecutive views of a real-world scene using the HMD device 102 according to an embodiment of the disclosure. The plurality of image frames 704A-N are obtained based on an input image 702 captured by an outward facing camera of the HMD device 102 at different views. The plurality of image frames 704A-N are previously captured frames which the user saw through the HMD device 102.

In an embodiment of the disclosure, the schematic diagram shows the movement of the user wearing the HMD device 102 from different views V0, V1, V2, V3, V4 at respective times T0, T1, T2, T3, T4. For example, the input image 702 corresponds to a living room. The landmarks or key features in the living room identified may include a table, a TV screen, wooden wall, center table, sofa, and the like. These landmarks are added to their respective groups and are represented using dotted colors based on the group that they are added to.

In an embodiment of the disclosure, the HMD controller 110 may generate a co-visibility graph corresponding to the plurality of image frames 704A-N. In an embodiment of the disclosure, the HMD controller 110 may generate a plurality of nodes 706A-N of the co-visibility graph corresponding to the plurality of image frames 704A-N. In an embodiment of the disclosure, the HMD controller 110 may generate edges of the co-visibility graph representing the co-visibility of landmarks between the plurality of image frames 704A-N. In one embodiment, the edges of the co-visibility graph may be generated when the number of landmarks commonly observed from different views corresponding to different nodes is greater than or equal to a threshold, or when the number of commonly observed landmarks accounts for at least a certain ratio of all landmarks. Here, the term “observed landmark” may refer to a landmark being included in the image frame corresponding to the view.

For example, the first image frame 704A is captured at time T0. At time T0, the user sees from the view V0, the table on the right, the partial TV screen, the wooden wall, and the partial center table. The second image frame 704B is captured at time T1. At time T1, the user sees from the view V1, the table on the right side, the whole TV, the partial sofa, and the center table. Multiple similar objects/features/landmarks are visible in the views V0 and V1. Thus, the views V0 and V1 are co-visible. Here, if the number of landmarks commonly observed from the views V0 and V1 is greater than or equal to a threshold, the HMD controller 110 may generate an edge 708 between a first node 706A corresponding to V0 and a second node 706B corresponding to V1.

The third image frame 704C is captured at time T2. At time T2, the user sees from the view V2, the table on the right side, the whole TV, the partial sofa, and the center table. The fourth image frame 704D is captured at time T3. At time T3, the user sees from the view V3, the table on the right, the whole TV screen, part of the wooden wall, the center table, and the sofa. Multiple similar objects/features/landmarks are visible in the views V0, V1, V1, and V3. Thus, the views V0, V1, V1, and V3 are co-visible. Here, similar to the way the edge 708 is generated between the first node 706A and the second node 706B, the HMD controller 110 may compare the number of landmarks commonly observed between different views with the threshold, and may generate edges between nodes of the co-visibility graph according to the comparison result.

The fifth image frame 704E depicts another view (V4) that is different from the living room displayed by the input image 702. Hence, the view V4 is not co-visible with the views V0, V1, V1, and V3, and will not be connected with these views in the co-visibility graph corresponding to the input image 902.

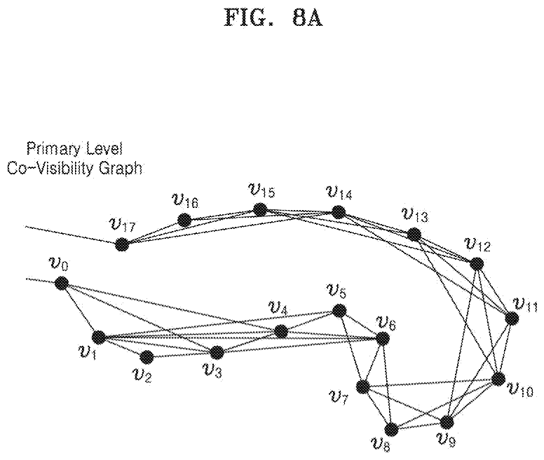

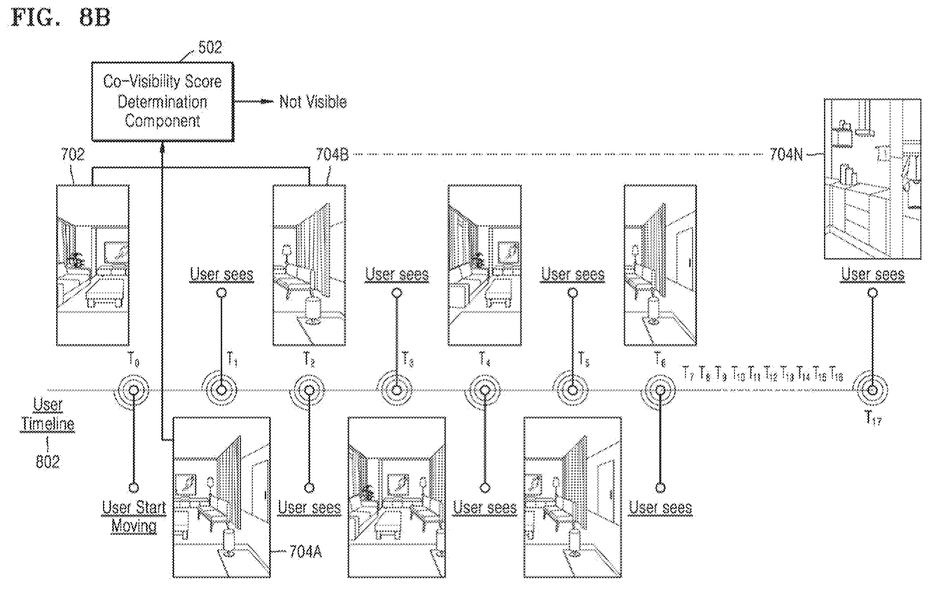

FIG. 8A is a schematic diagram that illustrates a primary level co-visibility graph according to the embodiments described herein. The primary level co-visibility graph of the real-world scene is generated for each group corresponding to at least one key image frame of the plurality of image frames 704A-N. The primary level co-visibility graph generated includes nodes and edges. The nodes match the views that the camera of the HMD device 102 records when the user proceeds throughout a time interval. The user moves across the time gap adding nodes corresponding to fresh or different viewpoints. When two nodes have a significant amount of matched features in the image frames 704A-N, then edges are created between them. The co-visibility of the objects or the similarities between the new and current views determines which edges are added. Furthermore, the primary level co-visibility graph only stores information on landmark features and co-visibility edges. The time gap between two nodes depends on the user movements. Whenever a new node is added to the co-visibility graph, new edges are added based on the co-visibility of the nodes.

The primary level co-visibility graph serves as a foundational structure for understanding the spatial relationships and visual continuity within a sequence of image frames 704A-N captured by the HMD device 102. By focusing on landmark features, the graph ensures that the significant visual elements are considered. This graph may be useful in applications such as augmented reality (AR) and virtual reality (VR). As the user navigates through different spaces, the graph dynamically updates to reflect new perspectives and maintain a relatively high level of accuracy in representing the real-world scene.

FIG. 8B is a schematic diagram that illustrates a user timeline 802 based on which the primary level co-visibility graph of FIG. 8A is generated according to the embodiment herein. The user timeline 802 includes the input image 702 received from the camera of the HMD device 102 and the plurality of image frames 704A-N obtained at different times T0-T17 based on the movements of the user. Further, the co-visibility score determination component 502 determines the co-visibility score of the image frames 704A-N. The co-visibility score is a means to quantify the degree of overlap or shared visibility between two or more views or poses of the HMD device 102 based on the common features or landmarks viewed. A higher co-visibility is indicated by a higher score.

The user timeline 802 provides a chronological context for the image frames 704A-N captured, allowing for a detailed analysis of how the user's movements influence the co-visibility graph. By examining the timeline, people may identify patterns in user behavior and optimize the performance of the HMD device 102 accordingly. For example, when some of the movements result in lower co-visibility scores, adjustments may be made to enhance feature detection and matching. Additionally, the timeline may be used to synchronize other data streams, such as sensor readings or user inputs, providing a comprehensive view of the user's interactions with the environment. This holistic approach enables more robust and immersive AR and VR experiences, as the system may more accurately track and respond to the user's actions in real-time.

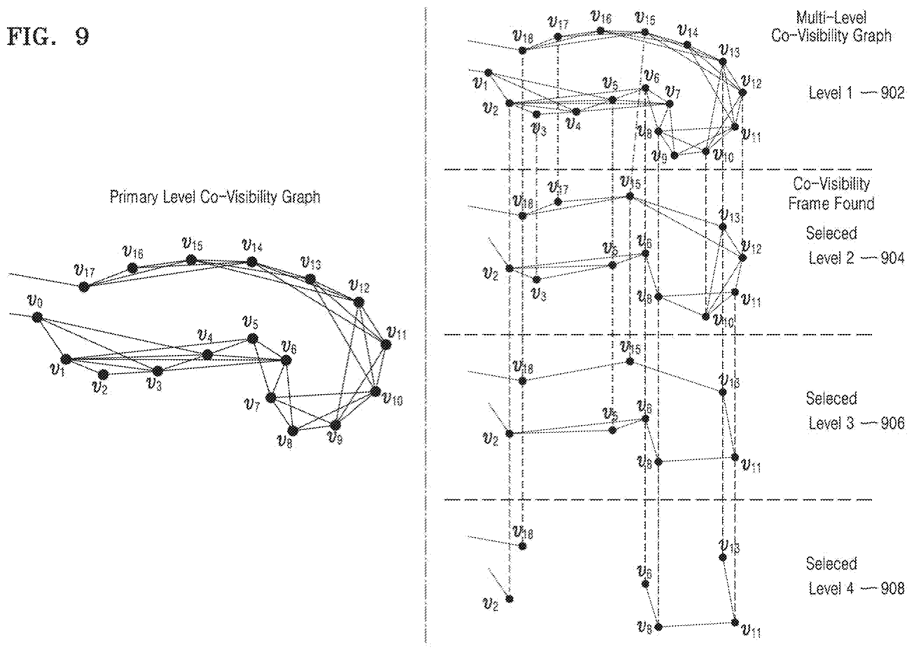

FIG. 9 is a schematic diagram that illustrates the generation of a multi-level co-visibility graph generated at different levels based on the primary level co-visibility graph of FIG. 8A according to an embodiment of the disclosure. The multi-level co-visibility graph stores the plurality of image frames 704A-N as nodes. The co-visible frames of the plurality of image frames 704A-N are connected as edges. The different levels of the multi-level co-visibility graph include level 1 902, level 2 904, level 3 906, and level 4 908. Level 1 902 corresponds to the primary level co-visibility graph of FIG. 8A. The co-visibility graph in level 1 902 is formed using all the features/landmarks in the input image 702 received from the real-world scene.

The co-visibility graph in level 2 904 is formed to include the features/landmarks having a co-visibility greater than a first threshold. The co-visibility graph in level 3 906 is formed to include the features/landmarks having a co-visibility greater than a second threshold. Further, the co-visibility graph in level 4 908 is formed to include the features/landmarks having a co-visibility greater than a third threshold. The first threshold is less than the second threshold and the third threshold. The second threshold is greater than the first threshold but less than the third threshold. The third threshold is greater than both the first threshold and the second threshold.

The thresholds (first threshold, second threshold, third threshold) are predetermined values that serve as benchmarks to determine whether the co-visibility is high enough to be considered acceptable for further processing or analysis. For example, setting a higher threshold may ensure that at least one key image frame of the plurality of image frames 704A-N is selected when there is significant overlap between the views, leading to more accurate mapping and localization. For example, if a co-visibility score of 20 results in a good overlap between the image frames 704A-N, then 20 may be set as the threshold. Scores below this might indicate insufficient overlap, due to which those image frames 704A-N may be discarded or reconsidered for later analysis.

Further, the multi-level co-visibility graph provides a hierarchical structure that allows for different levels of granularity in analyzing the co-visibility of features/landmarks. This hierarchical approach may be particularly beneficial in applications such as 3D reconstruction, augmented reality, and robotic navigation. For example, in a 3D reconstruction scenario, the higher levels of the co-visibility graph (e.g., level 3 906 and level 4 908 may be used to ensure that only overlapping image frames are considered, thereby enhancing the precision of the reconstructed model. Lower levels (e.g., level 1 902 and level 2 904) may be utilized for preliminary analysis or when computational resources are limited.

Additionally, the use of multiple thresholds allows for adaptive processing based on the specific requirements of the task at hand. For example, in augmented reality applications, a lower threshold might be used to quickly identify co-visible frames, even when the degree of accuracy decreases. In offline processing tasks such as detailed mapping or archival, higher thresholds may be employed to ensure that more reliable data is used. This flexibility in threshold selection makes the multi-level co-visibility graph a versatile tool for a wide range of applications.

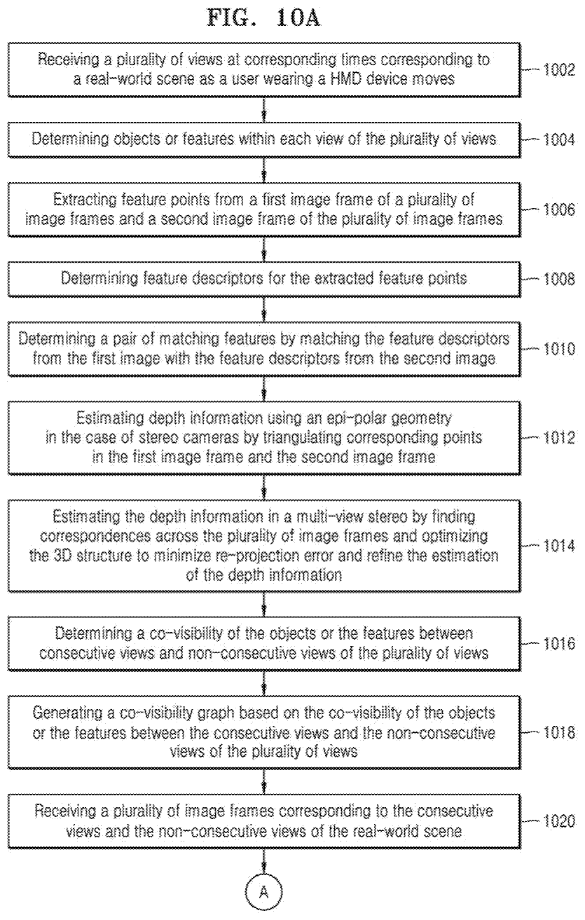

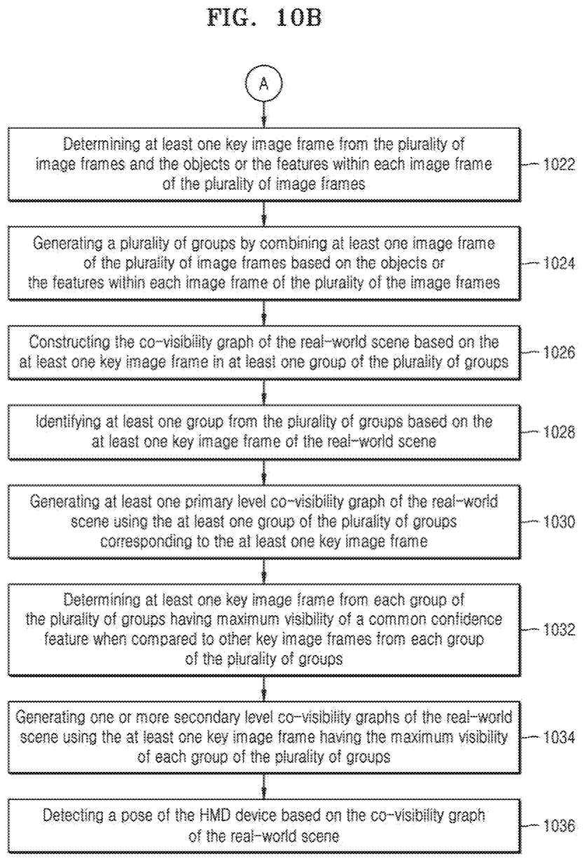

FIG. 10A and B are flow diagrams that illustrate a method for optimizing the searching of a previously viewed scene for the HMD device according to an embodiment of the disclosure. The method comprises steps 1002-1036. Each step is explained in detail below.

At step 1002, a plurality of views are received at corresponding times corresponding to a real-world scene as a user wearing the HMD device 102 moves. For example, the real-world scene may correspond to a living room, a home street view, office view, and the like. In order to provide an immersive visual experience, the HMD device 102 projects visual information straight into the user's eyes. The views may be captured using at least one outward-facing camera of the HMD device 102.

At step 1004, objects or features are determined within each view received in step 1202. The objects or features correspond to key elements, common elements within the views. For example, if the real-world scene corresponds to a living room, then the objects or features may refer to a sofa, television (TV), sofa table, and the like.

At step 1006, feature points are extracted from the image frames 704A-N determined for the views captured by the camera of the HMD device 102. For example, the feature points may include structures, edges, and objects in the image frames 704A-N. For example, the feature points may be extracted from a first image frame 704A, a second image frame 704B, a third image frame 704C, and the like for the image frames of the plurality of image frames 704A-N.

At step 1008, feature descriptors are determined for the feature points extracted in step 1006. The local image patches surrounding the identified feature points are represented numerically by the feature descriptors. It is possible to compare and match characteristics between multiple images using the feature descriptors. The feature descriptors are intended to be scale, translation, and illumination invariant. In addition, the feature descriptors are high-dimensional vectors that provide local image gradient data surrounding the feature points.

At step 1010, a pair of matching features are determined by matching the feature descriptors from the first image with the feature descriptors from the second image. The pair of matching features may be determined using descriptor matching techniques (for example, brute force matching, Lowe's ratio test, etc.).

At step 1012, depth information is estimated using an epipolar geometry in the case of stereo cameras by triangulating corresponding points in the image frames 704A-N. Triangulating related points in the image frames 704A-N from two stereo cameras is the process of estimating the depth information in stereo camera systems using epipolar geometry. This method computes the 3D coordinates of points in the real-world scene by using the geometric connections between the two camera viewpoints. Calibration of the stereo cameras yields both extrinsic (such as rotation and translation between the cameras) and intrinsic (such as focal length, principal point, and distortion coefficients) specifications. Next, feature matching algorithms are used to detect and match feature points between the stereo cameras. Next, a difference between the matching locations in the corrected images is calculated. The difference between the respective points' x-coordinates in the two images is known as the disparity. The disparity is inversely proportional to the depth information.

At step 1014, the depth information is estimated in a multi-view stereo by finding correspondences across the image frames 704A-N. In a multi-view stereo (MVS) configuration, depth information is estimated by identifying correspondences between multiple images and reconstructing 3D points using these correspondences. Bundle adjustment is used to fine-tune the postures acquired by the stereo cameras in order to reduce re-projection faults. The objective of this stage is to enhance the reconstruction accuracy by optimizing the camera settings and 3D points. The calculated 3D points for the depth information may then be used to create a depth map.

At step 1016, a co-visibility of the objects or features is determined between the consecutive views and the non-consecutive views received at step 1002. The views or scenes that are displayed one after another in a continuous and sequential manner are referred to as consecutive views. Consecutive views include watching a video where every frame plays after the previous one without any pauses or gaps. The views that are shown in non-consecutive views may have gaps, skips, or jumps between them, making them unrelated to one another. A non-consecutive perspective would be jumping ahead in a video to a new scene. Additionally, co-visibility shows that the same features or objects are present in all perspectives. When two image frames record the same subject matter from different perspectives or orientations, they are said to be co-visible. The co-visible area is the shared view area between the frames.

At step 1018, a co-visibility graph is generated based on the co-visibility of the objects or the features between the consecutive views and the non-consecutive views. A graph that illustrates the connections between various camera postures or perspectives based on the characteristics or objects visible from those viewpoints is known as a co-visibility graph. The resulting co-visibility graph has several layers, or it may be a multi-level co-visibility graph. Nodes and edges make up the created co-visibility graph. The nodes stand for a particular angle, camera position, or spot where the features or objects are viewed. The connections connecting two or more nodes show that the characteristics or objects observable from at least two perspectives significantly overlap. In this case, at least two points of view coexist or share visual components.

At step 1020, the plurality of image frames 704A-N are received corresponding to the consecutive views and the non-consecutive views of the real-world scene. Image frames may be discrete images or visuals that, when rapidly displayed one after the other, evoke the sense of motion.

At step 1022, at least one key frame is determined based on the image frames 704A-N received. A key image frame is a significant frame in a series of photos or a video that functions as an anchor or reference point to define motion, changes, or structure in both the consecutive and non-consecutive sequences. Rebuilding 3D buildings, making maps, predicting camera postures, and other tasks may all be accomplished with the help of at least one key image frame of the plurality of image frames 704A-N. The key image frame may be selected based on one or more criteria such as uniqueness, richness of features, coverage of previously unexplored areas, and the like. The features or objects contained in the key image frame(s) may then be identified.

At step 1024, a plurality of groups are generated or determined to group each image frame of the plurality of image frames 704A-N. The groups of the image frames 704A-N are determined based on the objects or features within each image frame and have common features. The objects or features within the image frames 704A-N is added as a part of at least one group. For example, the groups may include a highest confidence feature group, an intermediate confidence feature group, a less high confidence feature group, and a least confidence features group. For example, the objects or features may be added to the highest confidence feature group based on one or more criteria such as chances of staying at the same location are higher, have high contrast compared to its surroundings, static nature, distance from the user wearing the HMD device 102, and the like.

At step 1026 the co-visibility graph of the real-world scene is constructed based on the at least one key image frame in at least one group. For the groups, the HMD controller 110 first creates a primary level co-visibility graph of the real-world scene corresponding to at least one key image frame. Nodes and edges make up the primary level co-visibility graph that is generated. The nodes match the views that the camera of the HMD device 102 records when the user walks throughout a time interval. The user moves across the time gap, adding nodes corresponding to fresh or different viewpoints. If two nodes share a significant amount of matched characteristics in their associated pictures, then edges are created between them. The co-visibility of the items or the similarities between the new and current views determines which edges are added. Further, only landmark features and co-visibility edges information are stored in the primary level co-visibility graph.

At step 1028 at least one group is identified based on the at least one key frame of the real-world scene. The group may be identified based on the co-visibility of the features/landmarks within the key image frame.

At step 1030 at least one primary level co-visibility graph of the real-world scene for the groups corresponding to the key image frame is generated. The primary level co-visibility graph generated includes nodes and edges. The nodes correspond to views captured by the camera of the HMD device 102 as the user moves over a time gap. When the user keeps moving over the time gap, nodes corresponding to new views or different views are added. The co-visibility of the objects or the features between the new and current views determines which edges are to be added.

At step 1032 at least one key image frame for each group having a maximum visibility is determined. For each node in the primary level co-visibility graph, the HMD controller 110 computes or ascertains a co-visibility score. Based on the shared visibility or landmarks viewed, the co-visibility score is a way to measure the extent of overlap or shared visibility between two or more views or poses of the HMD device 102. A higher score denotes a greater co-visibility, which means that there are more similarities between the two viewpoints in terms of what may be viewed as well as shared landmarks or features.

At step 1034 one or more secondary level co-visibility graphs of the real-world scene are generated. The at least one key image frame with the greatest visibility for the groups are used to construct the secondary level co-visibility graphs. Every node's co-visibility score is compared to a threshold value. The nodes that have a co-visibility score higher than the predetermined threshold are taken into account and advanced to the next level. A map is used to store the frames, stances, and landmarks. The image frames 704A-N are stored as a node in the co-visibility graph and co-visible frames are connected as edges. The image frames 704A-N that are contained in the map are used to read the information about the landmarks.

At step 1036 a pose of the HMD device 102 worn by the user is detected based on the co-visibility graph generated of the real-world scene. The pose is detected using a pose detection process. At least one landmark is retrieved from the input image when they are received or recorded by the HMD device 102. In order to extract landmarks from the input image 702, one or more points of interest that correlate to characteristics within the image(s) be located. For example, if the input image 702 depicts a living room, the landmarks extracted may be a sofa, center table, television, and the like.

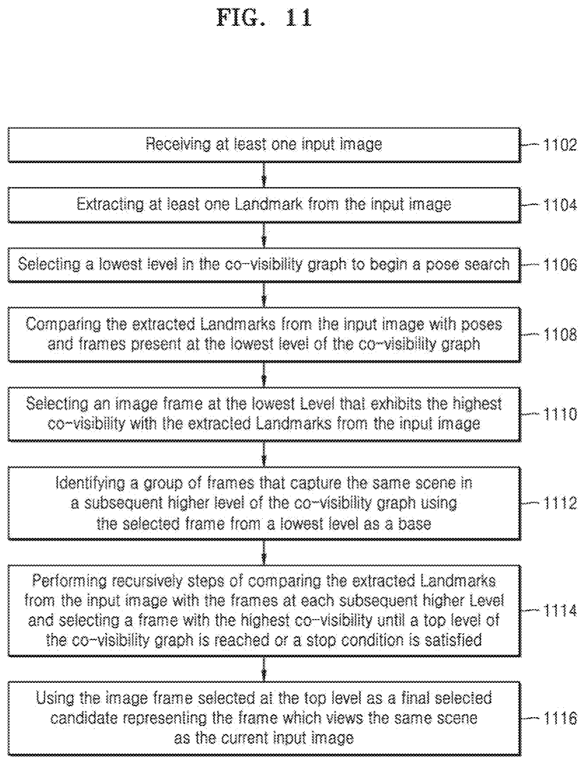

FIG. 11 is a flow diagram that illustrates a method for detecting a pose of the HMD device 102 according to the embodiment as disclosed herein. The method includes steps 1102-1116. Each step is explained in further detail below.

At step 1102, the input image 702 is received. The input image 702 received may correspond to a real-world scene currently or previously captured by the camera of the HMD device 102 worn by the user.

At step 1104, at least one landmark within the input image 702 received in step 1102 is extracted. Extracting landmarks from the input image 702 involves identifying one or more key points of interest that correspond to specific features within the image(s). For example, if the input image 702 depicts a living room, the landmarks extracted may be a sofa, center table, television, and the like.

At step 1106, a lowest level in the co-visibility graph generated is selected for beginning a pose search. The lowest level corresponds to a base level of the co-visibility graph where landmark observations are initially captured from multiple image frames 704A-N. The pose refers to the position and orientation of the extracted landmarks within the image frames 704A-N of the input image 702.

At step 1108, the extracted landmarks from the input image 702 are compared with poses and frames present at the lowest level of the co-visibility graph selected/identified in step 1106. For example, feature mapping techniques or geometric verification techniques may be used for finding correspondences. Once the correspondences are found, the HMD controller 110 assesses a similarity between the landmarks of the input image 702 and those in the co-visibility graph, potentially refining poses.

At step 1110, at least one image frame of the plurality of image frames 704A-N that exhibits the highest co-visibility with the extracted landmarks from the input image 702 at the lowest level of the co-visibility graph is selected. The co-visibility graph shows the correlations between the landmarks'visibility that are viewed in the image frames 704A-N. In this co-visibility graph, the node stands for the image frames and the edges indicate common landmarks among the image frames 704A-N. Using a feature matching procedure, the HMD controller 110 compares the retrieved landmarks with the landmarks found in the input image 702. Next, the number of matching landmarks between the input image 702 and the image frames 704A-N in the co-visibility graph is counted to calculate the co-visibility. Following that, the image frames 704A-N with the greatest number of matching landmarks are tracked in order to determine which frame has the highest co-visibility.

At step 1112, a group of image frames that capture the same scene in a subsequent higher level of the co-visibility graph is identified. The selected image frames 704A-N from the lowest level may be used as a base to identify the group of image frames. Higher levels record broader or more comprehensive views of the real-world scene, and the levels of the co-visibility graph indicate a hierarchical grouping of the image frames 704A-N. Group of image frames may, for example, refer to a collection of image frames 704A-N that are highly co-visible with the base frame and with each other (for example, sharing a large number of landmarks). At every succeeding higher level, the HMD controller 110 checks the image frames 704A-N with the landmarks that were retrieved from the input image 702. Consequently, until the top level of the co-visibility graph is reached, at least one image frame of the plurality of image frames 704A-N with the highest co-visibility is chosen.

At step 1114, the steps of comparing the extracted landmarks from the input image 702 with the frames at subsequent higher levels are recursively performed. The image frames 704A-N with the highest co-visibility are selected until a top level of the co-visibility graph is reached or when a stop condition is satisfied.

At step 1116, the image frames 704A-N selected at the top level of the co-visibility graph are used as a final selected candidate representing the frame which views the same scene as the current input image 702. Frame search may be performed in the co-visibility graph more successfully by keeping it in a multi-level hierarchical configuration. The co-visibility graph keeps image frames 704A-N at the levels by using stricter co-visibility rules. The co-visibility graph bounds the search region depending on the lower level search, so when the image frames 704A-N have to be searched, the search starts at the lowest level, progresses up, and only covers a subset of the picture frame count.

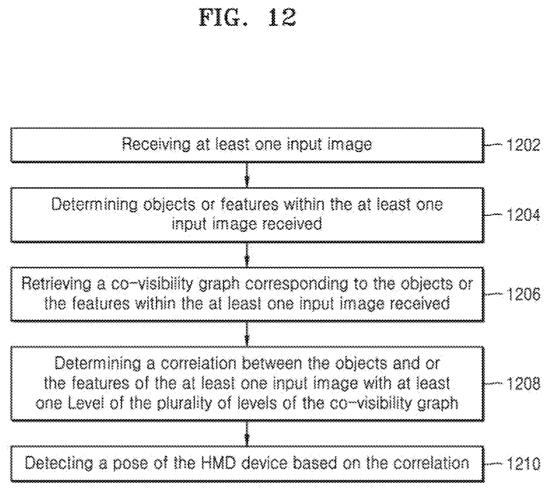

FIG. 12 is a flow diagram that illustrates a method for detecting a pose of the HMD device 102 using a pre-stored co-visibility graph according to an embodiment of the disclosure. The method includes steps 1202-1210. Each step is explained in further detail below.

At step 1202, the HMD device 102 receives the input image 902. The input image 902 includes a plurality of views at corresponding times corresponding to a real-world scene.

At step 1204, the HMD device 102 determines objects or features within the input image 702 received in step 1202. The objects or features correspond to key elements or common elements within the views. For example, if the real-world scene corresponds to a living room, then the objects or features may refer to a sofa, television (TV), sofa table, and the like. For example, if the real-world scene corresponds to an office, then the objects or features may refer to a cubical, office chair, laptop, drawers, and the like.

At step 1206, the HMD device 102 retrieves a co-visibility graph corresponding to the objects or the features within the at least one input image 902 received. The co-visibility graph includes a plurality of levels. Each level includes nodes that represent at least one view, and edges between the nodes that represent the co-visibility of the objects or the features between the different views. The co-visibility graph determined may be pre-stored in a memory 106 of the HMD device 102. For example, the memory 106 may store the co-visibility graphs using graph databases or relational databases. In relationship databases, the co-visibility graphs may be stored in tabular form. The nodes and edges of the co-visibility graph are retrieved and reconstructed using a graph processing library.

At step 1208, the HMD device 102 determines a correlation between the objects and the features of the input image 902 with at least one level of the co-visibility graph. The correlation refers to a relationship between the position of the objects and features in the input image 902 with the position of the same objects and features (this position may be represented using nodes) in a level of the co-visibility graph. The correlation refers to the degree of similarity or association between two nodes (typically representing camera views or 3D points) based on the shared visibility of certain objects or features. Based on the correlation determined/analyzed, the HMD device 102 may generate a correlation coefficient or score for each node. The correlation coefficient or score represents a degree to which different views or node of the co-visibility graph share common visible objects or features.

At step 1210, the HMD device 102 detects a pose of the HMD device 102 based on the correlation determined/analyzed in step 1208. For example, the pose may be detected using feature mapping techniques that matches the objects or features across multiple views or image frames 904A-N associated with the input image 902.

While the embodiments of the present disclosure have been described with reference to the accompanying drawings, the present invention is not limited to these embodiments and may be implemented in various other forms. Those skilled in the art may understand that other specific forms may be implemented without changing the technical spirit or essential characteristics of the present invention. Therefore, the embodiments described above should be understood as illustrative in all respects and not restrictive.

According to an aspect of the disclosure there is provided a method for optimizing searching of a previously viewed scene for a head-mounted display (HMD) device. In an embodiment of the disclosure, the method may include receiving, by the HMD device, a plurality of views corresponding to a real-world scene. In an embodiment of the disclosure, the method may include determining, by the HMD device, landmarks included in each view of the plurality of views. In an embodiment of the disclosure, the method may include determining, by the HMD device, a co-visibility of the landmarks between different views of the plurality of views, the co-visibility indicating same landmarks being included in the different views of the plurality of views. In an embodiment of the disclosure, the method may include generating, by the HMD device, a co-visibility graph based on the co-visibility of the landmarks between the different views of the plurality of views, the co-visibility graph comprising multiple levels, each level of the multiple levels comprises nodes corresponding to at least one view of the plurality of views, and edges between the nodes that represent the co-visibility of the landmarks between the at least one view of the plurality of views. In an embodiment of the disclosure, the method may include detecting, by the HMD device, a pose of the HMD device based on the co-visibility graph of the real-world scene.

In an embodiment of the disclosure, the method may include receiving, by the HMD device, a plurality of image frames corresponding to the plurality of views of the real-world scene. In an embodiment of the disclosure, the method may include determining, by the HMD device, at least one key image frame from the plurality of image frames, and the landmarks included in each image frame of the plurality of image frames. In an embodiment of the disclosure, the method may include generating, by the HMD device, a plurality of groups by combining at least one image frame of the plurality of image frames based on the landmarks included in each image frame of the plurality of image frames, each group of the plurality of groups comprising image frames having common landmarks. In an embodiment of the disclosure, the method may include constructing, by the HMD device, the co-visibility graph of the real-world scene based on the at least one key image frame in at least one group of the plurality of groups.

In an embodiment of the disclosure, the method may include identifying, by the HMD device, at least one group from the plurality of groups based on the at least one key image frame of the real-world scene. In an embodiment of the disclosure, the method may include generating, by the HMD device, at least one primary level co-visibility graph of the real-world scene using the at least one group of the plurality of groups corresponding to the at least one key image frame. In an embodiment of the disclosure, the method may include determining, by the HMD device, at least one key image frame from each group of the plurality of groups having maximum visibility of the common landmarks when compared to other key image frames from each group of the plurality of groups. In an embodiment of the disclosure, the method may include generating, by the HMD device, one or more secondary level co-visibility graphs of the real-world scene using the at least one key image frame having the maximum visibility of each group of the plurality of groups.

In an embodiment of the disclosure, the plurality of views may be received from at least one camera of the HMD device.

In an embodiment of the disclosure, the method may include generating, by the HMD device, new nodes corresponding to new views. In an embodiment of the disclosure, the method may include generating, by the HMD device, new edges based on the co-visibility of the landmarks between the new views and existing views. In an embodiment of the disclosure, the method may include storing, by the HMD device, an updated co-visibility graph including the new node and new edges.

In an embodiment of the disclosure, the method may include receiving, by the HMD device, at least one input image. In an embodiment of the disclosure, the method may include extracting, by the HMD device, at least one landmark from the input image. In an embodiment of the disclosure, the method may include selecting, by the HMD device, a lowest level in the co-visibility graph. In an embodiment of the disclosure, the method may include comparing, by the HMD device, the extracted landmarks from the input image with image frames at the lowest level of the co-visibility graph. In an embodiment of the disclosure, the method may include selecting, by the HMD device, at least one image frame of the plurality of image frames at the lowest level that exhibits the highest co-visibility score with the extracted landmarks from the input image, the co-visibility score indicating an extent to which the landmarks in the input image are visible in the plurality of image frames at a current level. In an embodiment of the disclosure, the method may include identifying, by the HMD device, a group of image frames that capture the same scene in a subsequent level that is greater than the lowest level of the co-visibility graph based on the at least image frame of the plurality of image frames selected from the lowest level as a base. In an embodiment of the disclosure, the method may include performing, by the HMD device, recursively comparing the extracted landmarks from the input image with image frames at each subsequent level greater than a previous level of the co-visibility graph and selecting image frames with the highest co-visibility until the highest level of the co-visibility graph is reached or a stop condition is satisfied. In an embodiment of the disclosure, the method may include using, by the HMD device, the at least image frame of the plurality of image frames selected at the highest level as a final selected candidate corresponding to the frame which views the same scene as the current input image.

In an embodiment of the disclosure, the method may include determining, by the HMD device, a first co-visibility score corresponding to the extent to which the landmarks in the input image are visible in the plurality of images frames at the current level of the co-visibility graph. In an embodiment of the disclosure, the method may include determining, by the HMD device, one or more second co-visibility scores corresponding to the extent to which the landmarks in the input image are visible in the plurality of images frames at each subsequent level greater than a previous level of the co-visibility graph. In an embodiment of the disclosure, the method may include determining, by the HMD device, whether the first co-visibility score is less than half of at least one second co-visibility score of the one or more second co-visibility scores. In an embodiment of the disclosure, the method may include performing, by the HMD device, one of stopping, by the HMD device, the pose search when the first co-visibility score is less than half of at least one second co-visibility score of the one or more second co-visibility scores and performing, by the HMD device, the pose search until the first co-visibility score is less than half of at least one second co-visibility score of the one or more second co-visibility scores.

In an embodiment of the disclosure, the method may include identifying, by the HMD device, distinct features and identifiable features included in at least one key image frame, the distinct features and identifiable features being selected from one of edges, corners, and textures. In an embodiment of the disclosure, the method may include generating, by the HMD device, feature descriptors that numerically correspond to the identifiable features. In an embodiment of the disclosure, the method may include bundling, by the HMD device, the generated feature descriptors into a comprehensive dataset and storing the comprehensive dataset for future use. In an embodiment of the disclosure, the method may include determining, by the HMD device, similarities and matches between a query image and the at least one key image frame based on the stored comprehensive dataset upon receiving the input image. In an embodiment of the disclosure, the method may include searching, by the HMD device, matching feature descriptors between the at least one key image frame and other images. In an embodiment of the disclosure, the method may include determining, by the HMD device, the co-visibility based on a count of the matching feature descriptors, wherein the higher co-visibility indicates a degree of similarity or co-visibility between the key image frame and the other images greater than a predetermined value.

In an embodiment of the disclosure, the method may include extracting, by the HMD device, feature points from a first image frame of the plurality of image frames and a second image frame of the plurality of image frames, the feature points comprising structures, edges, and objects in the plurality of image frames. In an embodiment of the disclosure, the method may include determining, by the HMD device, feature descriptors for the extracted feature points, wherein the feature descriptors are designed to be illumination, translation, and scale invariant, the feature descriptors corresponding to high-dimensional vectors encapsulating local image gradient information around each feature point. In an embodiment of the disclosure, the method may include determining, by the HMD device, a pair of matching features by matching the feature descriptors from the first image frame with the feature descriptors from the second image frame, each pair including a feature point from the first image frame and a corresponding feature point from the second image frame having descriptors that have a similarity over a predetermined threshold. In an embodiment of the disclosure, the method may include estimating, by the HMD device, depth information using an epi-polar geometry in case of stereo cameras by triangulating corresponding points in the first image frame and the second image frame.

According to an aspect of the disclosure, there is provided a method for optimizing searching of a previously viewed scene for a head-mounted display (HMD) device. In an embodiment of the disclosure, the method may include receiving, by the HMD device, at least one input image, wherein the at least one input image includes a plurality of views corresponding to a real-world scene. In an embodiment of the disclosure, the method may include determining, by the HMD device, landmarks included in the at least one input image received. In an embodiment of the disclosure, the method may include retrieving, by the HMD device, a co-visibility graph corresponding to the landmarks included in the at least one input image received, the co-visibility graph determined being pre-stored in a memory of the HMD device, and the co-visibility graph comprising a plurality of levels, each level includes nodes corresponding to at least one view of the plurality of views, and edges between the nodes corresponding to the co-visibility of the landmarks between the at least one view of the plurality of views. In an embodiment of the disclosure, the method may include determining, by the HMD device, a correlation between the landmarks of the at least one input image with at least one level of the plurality of levels of the co-visibility graph, and detecting, by the HMD device, a pose of the HMD device based on the correlation.

According to an aspect of the disclosure, there is provided a head-mounted display (HMD) device for optimizing searching of a previously viewed scene, including a memory storing a program or at least one instruction and at least one processor configure to individually or collectively execute the program or the at least one instruction. In an embodiment of the disclosure, the program or the at least one instruction, when executed individually or collectively by the at least one processor, cause the HMD device configured to receive a plurality of views corresponding to a real-world scene. In an embodiment of the disclosure, the program or the at least one instruction, when executed individually or collectively by the at least one processor, cause the HMD device configured to determine landmarks included in each view of the plurality of views. In an embodiment of the disclosure, the program or the at least one instruction, when executed individually or collectively by the at least one processor, cause the HMD device configured to determine a co-visibility of the landmarks between different views of the plurality of views, the co-visibility indicating same landmarks being included in the different views of the plurality of views. In an embodiment of the disclosure, the program or the at least one instruction, when executed individually or collectively by the at least one processor, cause the HMD device configured to generate a co-visibility graph based on the co-visibility of the landmarks between the different views of the plurality of views, the co-visibility graph comprising multiple levels, each level of the multiple levels comprises nodes corresponding to at least one view of the plurality of views, and edges between the nodes that represent the co-visibility of the landmarks between the at least one view of the plurality of views. In an embodiment of the disclosure, the program or the at least one instruction, when executed individually or collectively by the at least one processor, cause the HMD device configured to detect a pose of the HMD device based on the co-visibility graph of the real-world scene.

In an embodiment of the disclosure, the program or the at least one instruction, when executed individually or collectively by the at least one processor, cause the HMD device configured to receive a plurality of image frames corresponding to the plurality of views of the real-world scene. In an embodiment of the disclosure, the program or the at least one instruction, when executed individually or collectively by the at least one processor, cause the HMD device configured to determine at least one key image frame from the plurality of image frames, and the landmarks included in each image frame of the plurality of image frames. In an embodiment of the disclosure, the program or the at least one instruction, when executed individually or collectively by the at least one processor, cause the HMD device configured to generate a plurality of groups by combining at least one image frame of the plurality of image frames based on the landmarks included in each image frame of the plurality of image frames, each group of the plurality of groups comprising image frames having common landmarks. In an embodiment of the disclosure, the program or the at least one instruction, when executed individually or collectively by the at least one processor, cause the HMD device configured to construct the co-visibility graph of the real-world scene based on the at least one key image frame in at least one group of the plurality of groups.

In an embodiment of the disclosure, the program or the at least one instruction, when executed individually or collectively by the at least one processor, cause the HMD device configured to identify at least one group from the plurality of groups based on the at least one key image frame of the real-world scene. In an embodiment of the disclosure, the program or the at least one instruction, when executed individually or collectively by the at least one processor, cause the HMD device configured to generate at least one primary level co-visibility graph of the real-world scene based on the at least one group of the plurality of groups corresponding to the at least one key image frame. In an embodiment of the disclosure, the program or the at least one instruction, when executed individually or collectively by the at least one processor, cause the HMD device configured to determine at least one key image frame from each group of the plurality of groups having maximum visibility of the common landmarks when compared to other key image frames from each group of the plurality of groups. In an embodiment of the disclosure, the program or the at least one instruction, when executed individually or collectively by the at least one processor, cause the HMD device configured to generate one or more secondary level co-visibility graphs of the real-world scene using the at least one key image frame having the maximum visibility of each group of the plurality of groups.

In an embodiment of the disclosure, the plurality of views may be received from at least one camera of the HMD device.

In an embodiment of the disclosure, the program or the at least one instruction, when executed individually or collectively by the at least one processor, cause the HMD device configured to generate new nodes corresponding to new views. In an embodiment of the disclosure, the program or the at least one instruction, when executed individually or collectively by the at least one processor, cause the HMD device configured to generate new edges based on the co-visibility of the landmarks between the new views and existing views. In an embodiment of the disclosure, the program or the at least one instruction, when executed individually or collectively by the at least one processor, cause the HMD device configured to store an updated co-visibility graph including the new node and the new edges.

In an embodiment of the disclosure, the program or the at least one instruction, when executed individually or collectively by the at least one processor, cause the HMD device configured to receive at least one input image. In an embodiment of the disclosure, the program or the at least one instruction, when executed individually or collectively by the at least one processor, cause the HMD device configured to extract at least one landmark from the input image. In an embodiment of the disclosure, the program or the at least one instruction, when executed individually or collectively by the at least one processor, cause the HMD device configured to select a lowest level in the co-visibility graph. In an embodiment of the disclosure, the program or the at least one instruction, when executed individually or collectively by the at least one processor, cause the HMD device configured to compare the extracted landmarks from the input image with image frames at the lowest level of the co-visibility graph. In an embodiment of the disclosure, the program or the at least one instruction, when executed individually or collectively by the at least one processor, cause the HMD device configured to select at least one image frame of the plurality of image frames at the lowest level that exhibits the highest co-visibility score with the extracted landmarks from the input image, the co-visibility score indicating an extent to which the landmarks in the input image are visible in the plurality of image frames at a current level. In an embodiment of the disclosure, the program or the at least one instruction, when executed individually or collectively by the at least one processor, cause the HMD device configured to identify a group of image frames that capture the same scene in a subsequent level that is greater than the lowest level of the co-visibility graph based on the at least image frame of the plurality of image frames selected from the lowest level as a base. In an embodiment of the disclosure, the program or the at least one instruction, when executed individually or collectively by the at least one processor, cause the HMD device configured to perform recursively steps of comparing the extracted landmarks from the input image with image frames at each subsequent level higher than a previous level of the co-visibility graph and selecting image frames with the highest co-visibility until the highest level of the co-visibility graph is reached or a stop condition is satisfied. In an embodiment of the disclosure, the program or the at least one instruction, when executed individually or collectively by the at least one processor, cause the HMD device configured to uses the at least image frame of the plurality of image frames selected at the highest level as a final selected candidate corresponding to frame which views the same scene as the current input image.

In an embodiment of the disclosure, the program or the at least one instruction, when executed individually or collectively by the at least one processor, cause the HMD device configured to determine a first co-visibility score corresponding to the extent to which the landmarks in the input image are visible in the plurality of images frames at the current level of the co-visibility graph. In an embodiment of the disclosure, the program or the at least one instruction, when executed individually or collectively by the at least one processor, cause the HMD device configured to determine one or more second co-visibility scores corresponding to the extent to which the landmarks in the input image are visible in the plurality of images frames at each subsequent level greater than a previous level of the co-visibility graph. In an embodiment of the disclosure, the program or the at least one instruction, when executed individually or collectively by the at least one processor, cause the HMD device configured to determine whether the first co-visibility score is less than half of at least one second co-visibility score of the one or more second co-visibility scores. In an embodiment of the disclosure, the program or the at least one instruction, when executed individually or collectively by the at least one processor, cause the HMD device configured to perform one of: stopping the pose search when the first co-visibility score is less than half of at least one second co-visibility score of the one or more second co-visibility scores, and performing the pose search until the first co-visibility score is less than half of at least one second co-visibility score of the one or more second co-visibility scores.

In an embodiment of the disclosure, the program or the at least one instruction, when executed individually or collectively by the at least one processor, cause the HMD device configured to identify distinct features and identifiable features included in the at least one key image frame, the distinct features and identifiable features being selected from one of edges, corners, and textures. In an embodiment of the disclosure, the program or the at least one instruction, when executed individually or collectively by the at least one processor, cause the HMD device configured to generate feature descriptors that numerically correspond to the identifiable features. In an embodiment of the disclosure, the program or the at least one instruction, when executed individually or collectively by the at least one processor, cause the HMD device configured to bundle the generated feature descriptors into a comprehensive dataset and storing the comprehensive dataset for future use. In an embodiment of the disclosure, the program or the at least one instruction, when executed individually or collectively by the at least one processor, cause the HMD device configured to determine similarities and matches between a query image and the at least one key image frame based on the stored comprehensive dataset upon receiving the input image. In an embodiment of the disclosure, the program or the at least one instruction, when executed individually or collectively by the at least one processor, cause the HMD device configured to search matching feature descriptors between at least one key image frame and other images. In an embodiment of the disclosure, the program or the at least one instruction, when executed individually or collectively by the at least one processor, cause the HMD device configured to determine the co-visibility based on a count of the matching feature descriptors, the higher co-visibility indicating a degree of similarity or co-visibility between the key image frame and the other images greater than a predetermined value.

In an embodiment of the disclosure, the program or the at least one instruction, when executed individually or collectively by the at least one processor, cause the HMD device configured to extract feature points from a first image frame of the plurality of image frames and a second image frame of the plurality of image frames, wherein the feature points includes structures, edges, and objects in the plurality of image frames. In an embodiment of the disclosure, the program or the at least one instruction, when executed individually or collectively by the at least one processor, cause the HMD device configured to determine feature descriptors for the extracted feature points, the feature descriptors being designed to be illumination, translation, and scale invariant, the feature descriptors corresponding to high-dimensional vectors encapsulating local image gradient information around each feature point. In an embodiment of the disclosure, the program or the at least one instruction, when executed individually or collectively by the at least one processor, cause the HMD device configured to determines a pair of matching features by matching the feature descriptors from the first image frame with the feature descriptors from the second image frame, each pair comprising a feature point from the first image frame and a corresponding feature point from the second image frame having descriptors that have a similarity over a predetermined threshold. In an embodiment of the disclosure, the program or the at least one instruction, when executed individually or collectively by the at least one processor, cause the HMD device configured to estimates depth information using an epi-polar geometry in case of stereo cameras by triangulating corresponding points in the first image frame and the second image frame.

Various embodiments of the disclosure may be implemented or supported by one or more computer programs, and the computer programs may be formed from computer-readable program code and may be included in a computer-readable medium. In the disclosure, the terms “application” and “program” may refer to one or more computer programs, software components, instruction sets, procedures, functions, objects, classes, instances, related data, or a portion thereof suitable for implementation in computer-readable program code.

The “computer readable program code” may include various types of computer code including source code, object code, and executable code. The “computer-readable medium” may include various types of mediums accessible by a computer, such as read only memories (ROMs), random access memories (RAMs), hard disk drives (HDDs), compact discs (CDs), digital video discs (DVDs), or various types of memories. Also, the machine-readable storage medium may be provided in the form of a non-transitory storage medium. Here, the ‘non-transitory storage medium’ may be a tangible device and may exclude wired, wireless, optical, or other communication links for transmitting temporary electrical or other signals. Moreover, the ‘non-transitory storage medium’ may not distinguish between a case where data is semipermanently stored in the storage medium and a case where data is temporarily stored therein. For example, the “non-transitory storage medium” may include a buffer in which data is temporarily stored. The computer-readable medium may be any available medium accessible by a computer and may include volatile or non-volatile mediums and removable or non-removable mediums. The computer-readable medium may include a medium in which data may be permanently stored and a medium in which data may be stored and may be overwritten later, such as a rewritable optical disk or an erasable memory device.

According to an embodiment of the disclosure, the method according to various embodiments of the disclosure described herein may be included and provided in a computer program product. The computer program product may be traded as a product between a seller and a buyer. The computer program product may be distributed in the form of a machine-readable storage medium (e.g., a compact disc read only memory (CD-ROM)) or may be distributed (e.g., downloaded or uploaded) online through an application store or directly between two user devices. In the case of online distribution, at least a portion of the computer program product (e.g., a downloadable app) may be at least temporarily stored or temporarily generated in a machine-readable storage medium such as a manufacturer's server, a server of an application store, or a memory of a relay server. The foregoing descriptions of the disclosure are merely examples, and those of ordinary skill in the art will readily understand that various modifications may be made therein without materially departing from the spirit or features of the disclosure. For example, suitable results may be achieved even when the described technologies are performed in a different order from the described method and/or the components of the described system, structure, apparatus, or circuit are coupled or combined in a different form from the described method or are replaced or substituted by other components or equivalents thereof.

The various actions, acts, blocks, steps, or the like in the method is performed in the order presented, in a different order or simultaneously. Further, in some embodiments, some of the actions, acts, blocks, steps, or the like are omitted, added, modified, skipped, or the like without departing from the scope of the proposed method.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described, those skilled in the art will recognize that the embodiments herein may be practiced with modification within the scope of the embodiments as described herein.

While the embodiments of the present disclosure have been described with reference to the accompanying drawings, the present invention is not limited to these embodiments and may be implemented in various other forms. Those skilled in the art may understand that other specific forms may be implemented without changing the technical spirit or essential characteristics of the present invention. Therefore, the embodiments described above should be understood as illustrative in all respects and not restrictive.

What is claimed is:

1. A method for optimizing searching of a previously viewed scene for a head-mounted display (HMD) device, comprising:
receiving, by the HMD device, a plurality of views corresponding to a real-world scene;
determining, by the HMD device, landmarks included in each view of the plurality of views;
determining, by the HMD device, a co-visibility of the landmarks between different views of the plurality of views, the co-visibility indicating same landmarks being included in the different views of the plurality of views;
generating, by the HMD device, a co-visibility graph based on the co-visibility of the landmarks between the different views of the plurality of views, the co-visibility graph comprising multiple levels, each level of the multiple levels comprises nodes corresponding to at least one view of the plurality of views, and edges between the nodes that represent the co-visibility of the landmarks between the at least one view of the plurality of views; and
detecting, by the HMD device, a pose of the HMD device based on the co-visibility graph of the real-world scene.

2. The method as claimed in claim 1, generating, by the HMD device, the co-visibility graph based on the co-visibility of the landmarks between the different views of the plurality of views comprises:
receiving, by the HMD device, a plurality of image frames corresponding to the plurality of views of the real-world scene;
determining, by the HMD device, at least one key image frame from the plurality of image frames, and the landmarks included in each image frame of the plurality of image frames;
generating, by the HMD device, a plurality of groups by combining at least one image frame of the plurality of image frames based on the landmarks included in each image frame of the plurality of image frames, each group of the plurality of groups comprising image frames having common landmarks; and
constructing, by the HMD device, the co-visibility graph of the real-world scene based on the at least one key image frame in at least one group of the plurality of groups.

3. The method as claimed in claim 2, comprising:
identifying, by the HMD device, at least one group from the plurality of groups based on the at least one key image frame of the real-world scene;
generating, by the HMD device, at least one primary level co-visibility graph of the real-world scene using the at least one group of the plurality of groups corresponding to the at least one key image frame;
determining, by the HMD device, at least one key image frame from each group of the plurality of groups having maximum visibility of the common landmarks when compared to other key image frames from each group of the plurality of groups; and
generating, by the HMD device, one or more secondary level co-visibility graphs of the real-world scene using the at least one key image frame having the maximum visibility of each group of the plurality of groups.

4. The method as claimed in claim 1, wherein the plurality of views are received from at least one camera of the HMD device.

5. The method as claimed in claim 1, further comprises:
generating, by the HMD device, new nodes corresponding to new views;
generating, by the HMD device, new edges based on the co-visibility of the landmarks between the new views and existing views; and
storing, by the HMD device, an updated co-visibility graph including the new node and new edges.

6. The method as claimed in claim 2, wherein detecting, by the HMD device, the pose of the HMD device based on the co-visibility graph of the real-world scene comprises:
receiving, by the HMD device, at least one input image;
extracting, by the HMD device, at least one landmark from the input image;
selecting, by the HMD device, a lowest level in the co-visibility graph;
comparing, by the HMD device, the extracted landmarks from the input image with image frames at the lowest level of the co-visibility graph;
selecting, by the HMD device, at least one image frame of the plurality of image frames at the lowest level that exhibits the highest co-visibility score with the extracted landmarks from the input image, the co-visibility score indicating an extent to which the landmarks in the input image are visible in the plurality of image frames at a current level;
identifying, by the HMD device, a group of image frames that capture the same scene in a subsequent level that is greater than the lowest level of the co-visibility graph based on the at least image frame of the plurality of image frames selected from the lowest level as a base;
performing, by the HMD device, recursively comparing the extracted landmarks from the input image with image frames at each subsequent level greater than a previous level of the co-visibility graph and selecting image frames with the highest co-visibility until the highest level of the co-visibility graph is reached or a stop condition is satisfied; and
using, by the HMD device, the at least image frame of the plurality of image frames selected at the highest level as a final selected candidate corresponding to the frame which views the same scene as the current input image.

7. The method as claimed in claim 6, wherein the determining, by the HMD device whether the stop condition is satisfied comprises:
determining, by the HMD device, a first co-visibility score corresponding to the extent to which the landmarks in the input image are visible in the plurality of images frames at the current level of the co-visibility graph;
determining, by the HMD device, one or more second co-visibility scores corresponding to the extent to which the landmarks in the input image are visible in the plurality of images frames at each subsequent level greater than a previous level of the co-visibility graph;
determining, by the HMD device, whether the first co-visibility score is less than half of at least one second co-visibility score of the one or more second co-visibility scores;
performing, by the HMD device, one of:
stopping, by the HMD device, the pose search when the first co-visibility score is less than half of at least one second co-visibility score of the one or more second co-visibility scores; and
performing, by the HMD device, the pose search until the first co-visibility score is less than half of at least one second co-visibility score of the one or more second co-visibility scores.

8. The method as claimed in claim 6, wherein the determining, by the HMD device, the co-visibility comprises:
identifying, by the HMD device, distinct features and identifiable features included in at least one key image frame, the distinct features and identifiable features being selected from one of edges, corners, and textures;
generating, by the HMD device, feature descriptors that numerically correspond to the identifiable features;
bundling, by the HMD device, the generated feature descriptors into a comprehensive dataset and storing the comprehensive dataset for future use;
determining, by the HMD device, similarities and matches between a query image and the at least one key image frame based on the stored comprehensive dataset upon receiving the input image;
searching, by the HMD device, matching feature descriptors between the at least one key image frame and other images; and
determining, by the HMD device, the co-visibility based on a count of the matching feature descriptors, wherein the higher co-visibility indicates a degree of similarity or co-visibility between the key image frame and the other images greater than a predetermined value.

9. The method as claimed in claim 1, wherein determining, by the HMD device, the landmarks included in each view of the plurality of views comprises:
extracting, by the HMD device, feature points from a first image frame of the plurality of image frames and a second image frame of the plurality of image frames, the feature points comprising structures, edges, and objects in the plurality of image frames;
determining, by the HMD device, feature descriptors for the extracted feature points, wherein the feature descriptors are designed to be illumination, translation, and scale invariant, the feature descriptors corresponding to high-dimensional vectors encapsulating local image gradient information around each feature point;
determining, by the HMD device, a pair of matching features by matching the feature descriptors from the first image frame with the feature descriptors from the second image frame, each pair including a feature point from the first image frame and a corresponding feature point from the second image frame having descriptors that have a similarity over a predetermined threshold; and
estimating, by the HMD device, depth information using an epi-polar geometry in case of stereo cameras by triangulating corresponding points in the first image frame and the second image frame.

10. A method for optimizing searching of a previously viewed scene for a head-mounted display (HMD) device, comprising:
receiving, by the HMD device, at least one input image, wherein the at least one input image includes a plurality of views corresponding to a real-world scene;
determining, by the HMD device, landmarks included in the at least one input image received;
retrieving, by the HMD device, a co-visibility graph corresponding to the landmarks included in the at least one input image received, the co-visibility graph determined being pre-stored in a memory of the HMD device, and the co-visibility graph comprising a plurality of levels, each level comprises nodes corresponding to at least one view of the plurality of views, and edges between the nodes corresponding to the co-visibility of the landmarks between the at least one view of the plurality of views;
determining, by the HMD device, a correlation between the landmarks of the at least one input image with at least one level of the plurality of levels of the co-visibility graph; and
detecting, by the HMD device, a pose of the HMD device based on the correlation.

11. A head-mounted display (HMD) device for optimizing searching of a previously viewed scene, comprising:
a memory storing a program or at least one instruction; and
at least one processor configure to individually or collectively execute the program or the at least one instruction;
wherein the program or the at least one instruction, when executed individually or collectively by the at least one processor, cause the HMD device configured to:
receive a plurality of views corresponding to a real-world scene;
determine landmarks included in each view of the plurality of views;
determine a co-visibility of the landmarks between different views of the plurality of views, the co-visibility indicating same landmarks being included in the different views of the plurality of views;
generate a co-visibility graph based on the co-visibility of the landmarks between the different views of the plurality of views, the co-visibility graph comprising multiple levels, each level of the multiple levels comprises nodes corresponding to at least one view of the plurality of views, and edges between the nodes that represent the co-visibility of the landmarks between the at least one view of the plurality of views; and
detect a pose of the HMD device based on the co-visibility graph of the real-world scene.

12. The HMD device as claimed in claim 11, wherein the program or the at least one instruction, when executed individually or collectively by the at least one processor, cause the HMD device configured to:
receive a plurality of image frames corresponding to the plurality of views of the real-world scene;
determine at least one key image frame from the plurality of image frames, and the landmarks included in each image frame of the plurality of image frames;
generate a plurality of groups by combining at least one image frame of the plurality of image frames based on the landmarks included in each image frame of the plurality of image frames, each group of the plurality of groups comprising image frames having common landmarks; and
construct the co-visibility graph of the real-world scene based on the at least one key image frame in at least one group of the plurality of groups.

13. The HMD device as claimed in claim 12, wherein the program or the at least one instruction, when executed individually or collectively by the at least one processor, cause the HMD device configured to:
identify at least one group from the plurality of groups based on the at least one key image frame of the real-world scene;
generate at least one primary level co-visibility graph of the real-world scene based on the at least one group of the plurality of groups corresponding to the at least one key image frame;
determine at least one key image frame from each group of the plurality of groups having maximum visibility of the common landmarks when compared to other key image frames from each group of the plurality of groups; and
generate one or more secondary level co-visibility graphs of the real-world scene using the at least one key image frame having the maximum visibility of each group of the plurality of groups.

14. The HMD device as claimed in claim 11, wherein the plurality of views are received from at least one camera of the HMD device.

15. The HMD device as claimed in claim 11, wherein the program or the at least one instruction, when executed individually or collectively by the at least one processor, cause the HMD device configured to:
generate new nodes corresponding to new views;
generate new edges based on the co-visibility of the landmarks between the new views and existing views; and
store an updated co-visibility graph including the new node and the new edges.

16. The HMD device as claimed in claim 11, wherein the program or the at least one instruction, when executed individually or collectively by the at least one processor, cause the HMD device configured to:
receive at least one input image;
extract at least one landmark from the input image;
select a lowest level in the co-visibility graph;
compare the extracted landmarks from the input image with image frames at the lowest level of the co-visibility graph;
select at least one image frame of the plurality of image frames at the lowest level that exhibits the highest co-visibility score with the extracted landmarks from the input image, the co-visibility score indicating an extent to which the landmarks in the input image are visible in the plurality of image frames at a current level;
identify a group of image frames that capture the same scene in a subsequent level that is greater than the lowest level of the co-visibility graph based on the at least image frame of the plurality of image frames selected from the lowest level as a base;
perform recursively steps of comparing the extracted landmarks from the input image with image frames at each subsequent level higher than a previous level of the co-visibility graph and selecting image frames with the highest co-visibility until the highest level of the co-visibility graph is reached or a stop condition is satisfied; and
uses the at least image frame of the plurality of image frames selected at the highest level as a final selected candidate corresponding to frame which views the same scene as the current input image.

17. The HMD device as claimed in claim 16, wherein the program or the at least one instruction, when executed individually or collectively by the at least one processor, cause the HMD device configured to:
determine a first co-visibility score corresponding to the extent to which the landmarks in the input image are visible in the plurality of images frames at the current level of the co-visibility graph;
determine one or more second co-visibility scores corresponding to the extent to which the landmarks in the input image are visible in the plurality of images frames at each subsequent level greater than a previous level of the co-visibility graph;
determine whether the first co-visibility score is less than half of at least one second co-visibility score of the one or more second co-visibility scores;
perform one of:
stopping the pose search when the first co-visibility score is less than half of at least one second co-visibility score of the one or more second co-visibility scores; and
performing the pose search until the first co-visibility score is less than half of at least one second co-visibility score of the one or more second co-visibility scores.

18. The HMD device as claimed in claim 16, wherein the program or the at least one instruction, when executed individually or collectively by the at least one processor, cause the HMD device configured to:
identify distinct features and identifiable features included in the at least one key image frame, the distinct features and identifiable features being selected from one of edges, corners, and textures;
generate feature descriptors that numerically correspond to the identifiable features;
bundle the generated feature descriptors into a comprehensive dataset and storing the comprehensive dataset for future use;
determine similarities and matches between a query image and the at least one key image frame based on the stored comprehensive dataset upon receiving the input image;
search matching feature descriptors between at least one key image frame and other images; and
determine the co-visibility based on a count of the matching feature descriptors, the higher co-visibility indicating a degree of similarity or co-visibility between the key image frame and the other images greater than a predetermined value.

19. The HMD device as claimed in claim 11, wherein the program or the at least one instruction, when executed individually or collectively by the at least one processor, cause the HMD device configured to:
extract feature points from a first image frame of the plurality of image frames and a second image frame of the plurality of image frames, wherein the feature points includes structures, edges, and objects in the plurality of image frames;
determine feature descriptors for the extracted feature points, the feature descriptors being designed to be illumination, translation, and scale invariant, the feature descriptors corresponding to high-dimensional vectors encapsulating local image gradient information around each feature point;
determines a pair of matching features by matching the feature descriptors from the first image frame with the feature descriptors from the second image frame, each pair comprising a feature point from the first image frame and a corresponding feature point from the second image frame having descriptors that have a similarity over a predetermined threshold; and
estimates depth information using an epi-polar geometry in case of stereo cameras by triangulating corresponding points in the first image frame and the second image frame.
